(19) United States
(12) Patent Application Publication
(10) Pub. No.: US 2015/0048759 A1
(43) Pub. Date: Feb. 19, 2015

(54) LIGHTING DEVICE

(71) Applicant: SAMSUNG ELECTRONICS CO., LTD., Suwon-si (KR)

(72) Inventor: Sok Hyun JO, Incheon (KR)

(73) Assignee: SAMSUNG ELECTRONICS CO., LTD., Suwon-si (KR)

(21) Appl. No.: 14/276,639

(22) Filed: May 13, 2014

(30) Foreign Application Priority Data
Aug. 16, 2013 (KR) 10-2013-0097208

(51) Int. Cl. F21V 15/01; H05B 33/08; F21V 19/00; F21V 19/04; F21K 99/00; F21V 29/00

(52) U.S. Cl. CPC F21V 15/011; F21K 9/135; F21V 29/004; F21V 19/0045; F21V 19/045; H05B 33/0872; H05B 33/086; F21Y 2101/02
USPC 315/297; 362/249.02

(57) ABSTRACT

There is provided a lighting device including: a housing; and a plurality of light source modules detachably fixed to one surface of the housing, wherein the plurality of light source modules are divided radially on the basis of a central axis penetrating through a center of the housing and partial surfaces of the respective adjacent light source modules are combined to define an external shape of the lighting device.

### CROSS-REFERENCE TO RELATED APPLICATION

This application claims priority to and benefit of Korean Patent Application No. 2013-0097208 filed on Aug. 16, 2013, with the Korean Intellectual Property Office, the entire contents of which are incorporated herein by reference.

### TECHNICAL FIELD

The present disclosure relates to a lighting device.

### BACKGROUND

In the area of lighting devices, instead of conventional light bulbs, the use of light emitting diodes (LEDs) that consume a relatively small amount of power and have a relatively long lifespan as light sources, is increasing in prevalence.

However, it is not easy to implement light distribution at a luminous viewing angle identical to that of a light bulb due to light emission characteristics of a light emitting diode (LED). Also, a high power 1600-lm (lumens) lighting device cannot secure sufficient cooling performance through natural cooling. In order to overcome this, some lighting devices include a cooling fan to enhance heat dissipation efficiency through forced cooling. However, a problem occurs when a size of the lighting device increases corresponding to a space occupied by the cooling fan, exceeding the American National Standards Institute (ANSI) standards.

In addition, when an error occurs in some of a set of LEDs used for high power, the entirety of a corresponding lighting device needs to be replaced, increasing cost. This makes it difficult to replace light bulbs with LED lamps.

### SUMMARY

An aspect of the present disclosure provides a lighting device including a light source with a long lifespan and enhanced optical power by maximizing heat dissipation efficiency by overcoming limited heat dissipation efficiency in conventional natural cooling.

An aspect of the present disclosure relates to providing the lighting device having a size within a range of the ANSI standard, while having enhanced heat dissipation efficiency according to a high output (or high power).

However, objects of the present disclosure are not limited thereto and objects and effects that may be recognized from technical solutions or exemplary embodiments described hereinafter may also be included although not explicitly mentioned.

According to an aspect of the present disclosure, a lighting device includes: a housing; and a set of light source modules detachably fixed to one surface of the housing, wherein the set of light source modules are divided radially on the basis of a central axis penetrating through the center of the housing and partial surfaces of the respective adjacent light source modules are combined to define an external shape of the lighting device.

The set of light source modules may have flow paths allowing air to flow therethrough between the set of light source modules and the housing.

The set of light source modules may each have a slider formed in a surface thereof facing the housing and fastened to the housing.

The set of light source modules may be in line-contact with the housing through one protruded surface of each of the sliders, and may be spaced apart from the housing by the sliders interposed between the set of light source modules and the housing to form the flow paths.

Each of the light source modules may include a frame having a first surface and a second surface facing one another. The second surface may have a recess depressed toward the first surface, defined as a space formed by a sloped surface sloped from the second surface toward the bottom surface and a pair of side walls extending from both edges of the bottom surface and connected to both edges of the sloped surface. The light source module may also include a light source placed on a bottom surface of the frame, and a cover covering the light source.

The pair of side walls may satisfy the following conditional expression:

θ=360°/n

When an intersection point of the central axis and virtual extending lines of the pair of side walls can be used as a vertex, “θ” is an angle between the pair of side walls on the basis of the vertex and “n” is a number of the light source modules.

The housing may further include a fixing unit protruded from the one surface thereof along the central axis, and a set of slots may be provided on the circumference of the side of the fixing unit to allow the sliders to be fastened thereto.

The set of slots may each extend from an open end of the fixing unit to the one surface, formed to be spaced apart on the circumference of the side of the fixing unit and arranged to be parallel to the central axis.

A set of grooves may each be formed on the one surface of the housing and connected to the set of slots, and the set of grooves may each extend radially from the fixing unit positioned in the center to an outer surface of the housing.

The light source may include a board and a set of light emitting devices placed on the board.

Each of the light emitting devices may include a set of nano-light emitting structures and a filler material filling spaces between the set of nano-light emitting structures. Each of the nano-light emitting structures may include a nano-core as a first conductivity-type semiconductor layer and an active layer and a second conductivity-type semiconductor layer covering the nano-core as shell layers.

According to another aspect of the present disclosure, a lighting device may include a housing having a fixing unit, and a set of light source modules divided radially on the basis of a central axis passing through the center of the fixing unit and detachably fastened to the fixing unit in a length direction to surround the fixing unit. Partial surfaces of the respective adjacent light source modules may be combined to define an external shape of the lighting device.

Each light source module from the set of light source modules may have a slider protruded from the center of a lower surface facing the housing toward the housing and extending in the length direction of the fixing unit. Protruded ends of the sliders may be partially fastened to a set of slots formed on the circumference of the side of the fixing unit.

Lower surfaces of the set of light source modules may be spaced apart from a surface of the housing, and flow paths allowing air to flow therethrough may be formed between the lower surfaces of the set of light source modules and the surface of the housing.

Gaps allowing air to be released therethrough may exist between the set of divided light source modules.

### BRIEF DESCRIPTION OF DRAWINGS

The above and other aspects, features and other advantages of the present disclosure will be more clearly understood from the following detailed description taken in conjunction with the accompanying drawings, in which like reference characters may refer to the same or similar parts throughout the different views. The drawings are not necessarily to scale, emphasis instead being placed upon illustrating the principles of the embodiments of the inventive concept. In the drawings, the thickness of layers and regions may be exaggerated for clarity.

FIG. 1 is a perspective view schematically illustrating a lighting device according to an exemplary embodiment of the present disclosure.

FIG. 2 is an exploded perspective view schematically illustrating the lighting device of FIG. 1.

FIGS. 3(a) and 3(b) are a side view and a plan view schematically illustrating a housing of the lighting device of FIG. 1.

FIGS. 4A and 4B are perspective views schematically illustrating a light source module of the lighting device of FIG. 1.

FIG. 5 is a cross-sectional view schematically illustrating a frame of the light source module of FIGS. 4A and 4B.

FIG. 6 is a perspective view schematically illustrating a state in which air flows along a flow path in the lighting device of FIG. 1.

FIG. 7 is a graph showing a light distribution curve of the lighting device of FIG. 1.

FIGS. 8A and 8B are a perspective view and a cross-sectional view schematically illustrating another exemplary embodiment of the light source module of the lighting device of FIG. 1.

FIG. 9 is a cross-sectional view schematically illustrating an example of a substrate employable in lighting devices according to various exemplary embodiments of the present disclosure.

FIG. 10 is a cross-sectional view schematically illustrating another example of the substrate.

FIG. 11 is a cross-sectional view schematically illustrating a modification of the substrate of FIG. 10.

FIGS. 12 through 15 are cross-sectional views schematically illustrating various examples of the substrate.

FIG. 16 is a cross-sectional view schematically illustrating an example of a light emitting device (or an LED chip) employable in lighting devices according to various exemplary embodiments of the present disclosure.

FIG. 17 is a cross-sectional view schematically illustrating another example of the light emitting device (or the LED chip) of FIG. 16.

FIG. 18 is a cross-sectional view schematically illustrating another example of the light emitting device (or the LED chip) of FIG. 16.

FIG. 19 is a cross-sectional view illustrating an example of an LED chip as a light emitting device employable in lighting devices according to various exemplary embodiments of the present disclosure, mounted on a board allowing a chip to be mounted thereon (or a mounting board.

FIG. 20 is a view illustrating the CIE 1931 color space chromaticity diagram.

FIG. 21 is a block diagram schematically illustrating a lighting system according to an exemplary embodiment of the present disclosure.

FIG. 22 is a block diagram schematically illustrating a detailed configuration of a lighting unit of the lighting system illustrated of FIG. 21.

FIG. 23 is a flow chart illustrating a method for controlling the lighting system illustrated of FIG. 21.

FIG. 24 is a view schematically illustrating the way in which the lighting system illustrated of FIG. 21 is used.

FIG. 25 is a block diagram of a lighting system according to another exemplary embodiment of the present disclosure.

FIG. 26 is a view illustrating a format of a ZigBee signal according to an exemplary embodiment of the present disclosure.

FIG. 27 is a view illustrating a sensing signal analyzing unit and an operation control unit according to an exemplary embodiment of the present disclosure.

FIG. 28 is a flow chart illustrating an operation of a wireless lighting system according to an exemplary embodiment of the present disclosure.

FIG. 29 is a block diagram schematically illustrating components of a lighting system according to another exemplary embodiment of the present disclosure.

FIG. 30 is a flow chart illustrating a method for controlling a lighting system according to an exemplary embodiment of the present disclosure.

FIG. 31 is a flow chart illustrating a method for controlling a lighting system according to another exemplary embodiment of the present disclosure.

FIG. 32 is a flow chart illustrating a method for controlling a lighting system according to another exemplary embodiment of the present disclosure.

### DETAILED DESCRIPTION

Hereinafter, exemplary embodiments of the present disclosure will be described in detail with reference to the accompanying drawings.

The disclosure may, however, be exemplified in many different forms and should not be construed as being limited to the specific exemplary embodiments set forth herein. Rather, these exemplary embodiments of the present disclosure are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

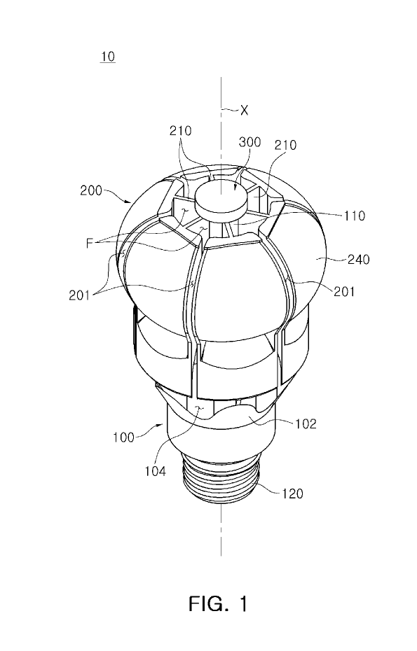

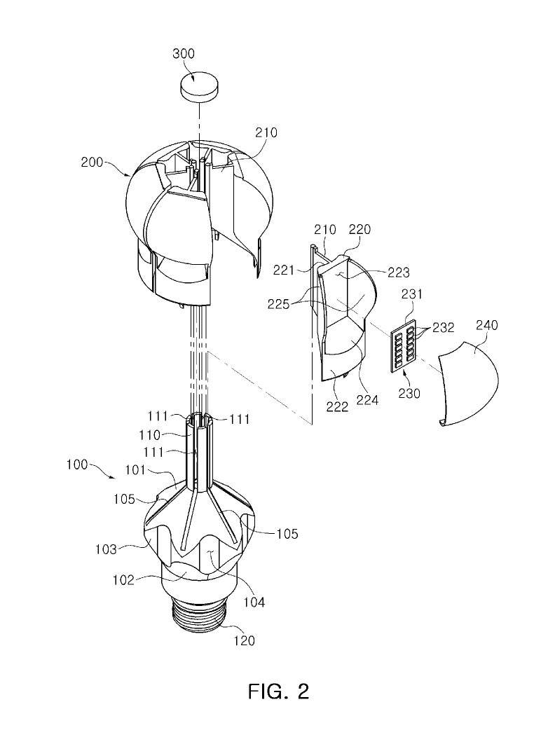

A lighting device according to an exemplary embodiment of the present disclosure will be described with reference to FIGS. 1 and 2. FIG. 1 is a perspective view schematically illustrating a lighting device according to an exemplary embodiment of the present disclosure, and FIG. 2 is an exploded perspective view schematically illustrating the lighting device of FIG. 1.

Referring to FIGS. 1 and 2, a lighting device 10 according to an exemplary embodiment of the present disclosure may include a housing 100 having a fixing unit 110 provided therein and a set of light source modules 200 fastened to the housing 100 through the fixing unit 110.

The housing 100, a basic body of the lighting device 10, includes one surface 101, another surface 102 opposing the one surface 101, and an outer surface 103 connecting the one surface 101 and the other surface 102. The one surface 101 and the other surface 102 may each be protruded and sloped toward a central axis X penetrating through a center of the housing 100. Recess portions 104 may be formed at predetermined intervals on a circumference of the outer surface 103, such that they are parallel to the central axis X, for air circulation.

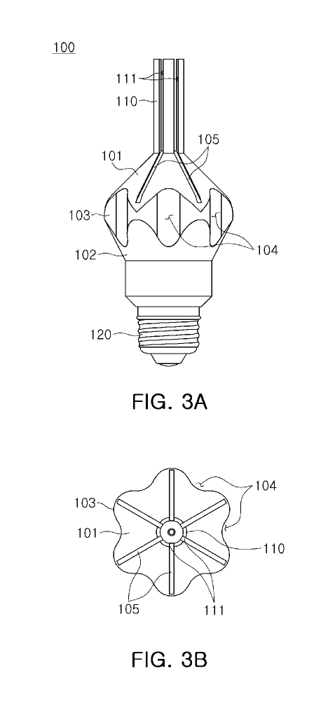

In detail, as illustrated in FIGS. 2 and 3, the fixing unit 110 may be provided in the one surface 101 of the housing 100. Furthermore, a terminal unit 120 for a connection to an external power source may be provided in the other surface 102. A set of grooves 105 pointing toward the outer surface 103 may extend radially from the fixing unit 110 on the one surface 101 having the fixing unit 110.

The housing 100 may be formed by injection-molding polycarbonate (PC).

The fixing unit 110 may have a pipe-shaped structure protruded from the center of the one surface 101 and extended to have a predetermined length along the central axis X. A set of slots 111 may be formed on the circumference of the side of the fixing unit 110.

The set of slots 111 may each extend from an open end of the fixing unit 110 to the one surface 101, located on the opposite side, in a length direction of the fixing unit 110, and may be spaced apart from one another along the circumference of the side of the fixing unit 110 so as to be arranged to be parallel to the central axis X.

The fixing unit 110 may be integrally formed with the housing 100 such that it is provided on the one surface 101, or may be separately formed and assembled to the one surface 101.

Meanwhile, the set of grooves 105 provided on the one surface 101 can each be connected to the set of slots 111. Thus, a number of slots in set 111 and a number of slots in set 105 may be equivalent. The recess portions 104 provided on the outer surface 103 of the housing 100 may be disposed to be positioned in regions between the slots 111.

The terminal unit 120 may be, for example, detachably fastened and electrically connected to a socket. The terminal unit 120 may be formed of a material having electrical conductivity, such as a metal. In the present exemplary embodiment, the terminal unit 120 has an Edison-type structure with screw fastening type thread formed thereon, but the present inventive concept is not limited thereto.

Meanwhile, various electronic devices such as a power supply unit (PSU), a sensor device, and the like, may be installed in the housing 100.

The set of light source modules 200 are each detachably fastened to the one surface 101 of the housing 100 along the circumference of the fixing unit 110 through sliders 210 fastened to the set of slots 111, and may implement a light distribution identical to that of a general light bulb.

In detail, the set of light source modules 200 may be divided radially and equally along the circumference of the side of the fixing unit 110 on the basis of the central axis X to surround the fixing unit 110 having a pipe-shaped structure. Gaps 201 may exist at predetermined intervals between a set of divided light source modules 200.

In the exemplary embodiment of FIGS. 1 and 2, it is illustrated that the set of light source modules 200 are provided as six divided light source modules, but the present inventive concept is not limited thereto. For example, the set of light source modules 200 may be variously divided as two, three, four, or more light source modules.

Each of the light source modules 200 may have the slider 210 protruded from a lower surface thereof, facing the housing 100, toward the housing 100 and may be detachably fastened to the housing 100 as the sliders 210 are slidably inserted into the slots 111 in a length direction of the fixing unit 110.

The sliders 210 may be protruded from the centers of lower surfaces of the light source modules 200 by a predetermined length and extend in the length direction of the fixing unit 110, and have a plate-like shape. The sliders 210 may have a thickness corresponding to the space of the slots 111 as a whole.

Protruded ends of the sliders 210 may be partially fastened to the slots 111 of the fixing unit 110, and the other portions thereof may be inserted into the grooves 105 formed on the one surface 101 of the housing 100. Thus, the light source modules 200 may be stably fixed to and supported by the housing 100 through the sliders 210.

In this manner, the light source modules 200 according to the present exemplary embodiment are easily fastened to the slots 111 formed in the fixing unit 110 of the housing 100 through the sliders 210 in a sliding manner, and ease of assembly of the light source modules 200 can be secured.

Meanwhile, a stopper 300 may be provided and fastened to the open end of the fixing unit 110 in a state in which the set of light source modules 200 are fastened to the fixing unit 110 of the housing 100. The stopper 300 may be detachably inserted into the open end of the fixing unit 110 to fix the set of light source modules 200 such that the light source modules 200 may not be easily released from the slots 111.

Hereinafter, the light source module 200 will be described in detail with reference to FIGS. 2, 4A-4B, and 5.

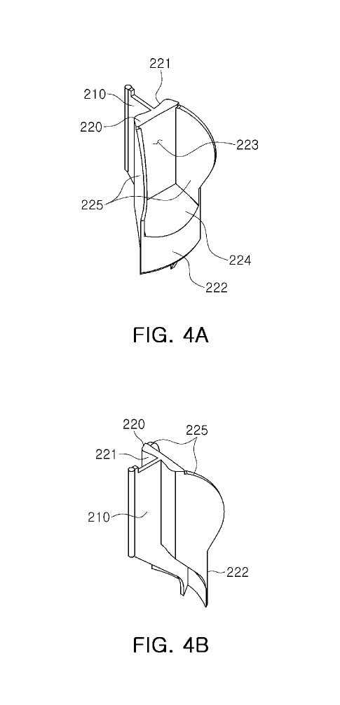

As illustrated in FIGS. 2 and 4A-4B, the light source module 200 may include a frame 220, a light source 230 mounted on the frame 220, and a cover 240 covering the light source 230.

The frame 220 may have a first surface 221 and a second surface 222, and the second surface 222 may have a recess 223 depressed toward the first surface 221 and having a cup structure. The recess 223 may be defined as a space formed by a sloped surface 224 downwardly sloped from the second surface 222 to a bottom surface of the recess 223 and a pair of side walls 225 extending from both edges of the bottom surface and connected to both edges of the sloped surface 224. Thus, the quadrangular bottom surface of the recess 223 may have a partially open structure surrounded by three surfaces comprising the sloped surface 224 and the pair of side walls 225.

The pair of side walls 225 may each have an upper surface as a curved surface protruded toward an upper portion of the second surface 222. The upper surfaces of the pair of side walls 225 and the second surface 222 may define an external shape of the lighting device 10 together with the cover 240 as described hereinafter in a state in which the light source modules 200 are fastened to the housing 100.

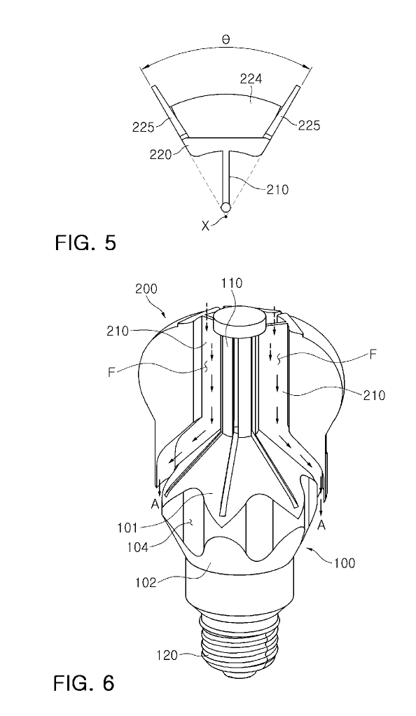

Meanwhile, as illustrated in FIG. 5, the pair of side walls 225 may be opened at a predetermined angle and sloped with respect to the bottom surface. In this case, the pair of side walls 225 may have a structure that satisfies the following conditional expression:

θ=360°/n

Here, when an intersection point of the central axis X and virtually extended lines of the pair of side walls 225 can be used as a vertex, “θ” is an angle between the pair of side walls 225 on the basis of the vertex and “n” is a number of the light source modules 200.

For example, in the case in which the number of the light source modules 200 is 6 (n=6), the pair of side walls 225 may be opened at the angle of 60° (θ=60°). Thus, the set of light source modules 200 may be divided radially and equally on the basis of the central axis X.

The first surface 221 of the frame 220 may be defined as a lower surface of the light source module 200 facing the housing 100. The slider 210 may be vertically protruded from the center of the first surface 221 in a length direction.

The slider 210 and the frame 220 may be integrally formed and may be made of a metal such as aluminum (Al) for heat dissipation, but the present inventive concept is not limited thereto. Thus, the frame 220 may serve as a heat sink as well as having a function of a fixed structure supporting the light source 230.

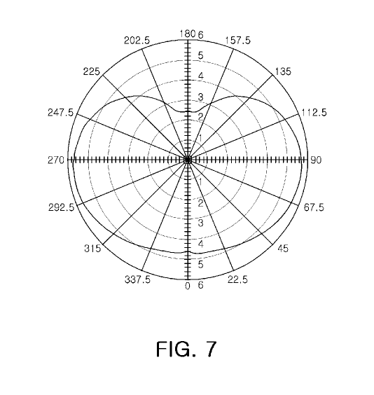

Meanwhile, as illustrated in FIG. 6, the set of light source modules 200 fastened to the housing 100 through the sliders 210 are in line contact with the housing 100 through the protruded ends of the sliders 210. The set of light source modules 200, in a state of being spaced apart from the housing 100 at a predetermined interval by the slider 210 interposed therebetween, may be supported by the sliders 210 and fixed to the housing 100.

Flow paths F, defined as a space formed by lower surfaces of the set of the light source modules 200 and the surface of the housing 100 being spaced apart from each other at a predetermined interval, may be provided therebetween. The flow paths F may allow ambient air A to vertically flow through the lighting device 10 along the central axis X. Through continuous air circulation, heat generated by the light source modules 200 and the housing 100 may be dissipated externally.

In particular, since the housing 100 and the light source modules 200 are partially in contact by the sliders 210, the surface of the housing 100 and the lower surfaces of the light source modules 200 are mostly exposed to the flow paths F. Also, the sliders 210 traversing the flow paths F so as to be exposed may serve as heat dissipation fins. The flow paths F may be connected to the gaps 201 provided between the set of divided light source modules 200, and air may flow radially as well. Thus, heat dissipation efficiency of the lighting device 10 through natural cooling may be maximized.

The light source 230 may be placed on the bottom surface of the recess 223. The light source 230 may include a board 231 and a set of light emitting devices 232 placed on the board 231.

The board 231 may be an FR4-type printed circuit board (PCB) and may be made of an organic resin material containing epoxy, triazine, silicon (Si), polyimide, and the like, and any other organic resin material, or may be made of a ceramic material such as silicon nitride, AlN, Al₂O₃, or the like, or a metal and a metal compound, and may include a metal-core printed circuit board (MCPCB), a metal copper-clad laminate (MCCL), and the like.

The set of light emitting devices 232 may be mounted on the board 231 and electrically connected thereto. The set of light emitting devices 232 may be spaced apart from one another at predetermined intervals and arranged in a length direction of the board 231.

Any type of photoelectric device may be used as the light emitting device 232, as long as it generates light having a predetermined wavelength by power applied thereto from the outside. The light emitting device 232 may include a semiconductor light emitting diode (LED) in which a semiconductor layer can be epitaxially grown on a growth substrate. The light emitting device 232 may emit blue light, green light, or red light according to a material contained therein, and may emit white light.

The light emitting devices 232 may have a lamination structure including an n-type semiconductor layer, a p-type semiconductor layer, and an active layer disposed therebetween, but the present inventive concept is not limited thereto. Also, the active layer may be formed of a nitride semiconductor including InₓAl_{y}Ga_{1-x-y}N (0≦x≦1, 0≦y≦1, 0≦x+y≦1) having a single or multi-quantum well structure.

LED chips having various structures or various types of LED package including such LED chips may be used in the light emitting devices 232. The board 231 and the light emitting devices 232 will be described in detail hereinbelow.

The cover 240 may be fastened to the frame 220 to cover and protect the light source 230. As illustrated in FIGS. 1 and 2, the cover 240 may have a shape corresponding to the protruded curved surfaces of the pair of side walls 225, and may be disposed between the pair of side walls 225 and fastened to cover the recess 223.

The cover 240 may be made from a transparent resin material, such as polycarbonate (PC), polymethylmethacrylate (PMMA), or the like. Also, the cover 240 may be made from a glass material, but the present inventive concept is not limited thereto.

The cover 240 may contain a light dispersion material in an amount of 3% to 15%. The light dispersion material may include one or more of materials selected from the group consisting of SiO₂, TiO₂, and Al₂O₃, for example. If the light dispersion material is contained in the amount of less than 3%, light may not be sufficiently dispersed and light dispersion effect may not occur. If the light dispersion material is contained in the amount of more than 15%, an amount of light discharged outwardly through the cover 240 may be reduced, degrading light extraction efficiency.

In addition to the light dispersion material, the cover 240 may contain or be coated with a wavelength conversion material, for example, a phosphor.

In this manner, the lighting device 10 including the set of light source modules 200 and the housing 100 to which the light source modules 200 are detachably assembled in a sliding manner may implement a light distribution at a luminous viewing angle identical to that of a conventional light bulb by using LEDs as a point light source.

As illustrated in FIG. 6, since the flow paths F for cooling are provided between the housing 100 and the light source modules 200, sufficient cooling performance can be secured even in a high output lighting device of a 1600 lm class within the ANSI standard (e.g., ANSI A21).

FIG. 7 schematically illustrates a light distribution curve according to an interpretation of a light distribution. As illustrated, it can be seen that the light distribution has an average light intensity at the level of +10%/−15% at ±135°, satisfying a luminous viewing angle light distribution reference (±20%).

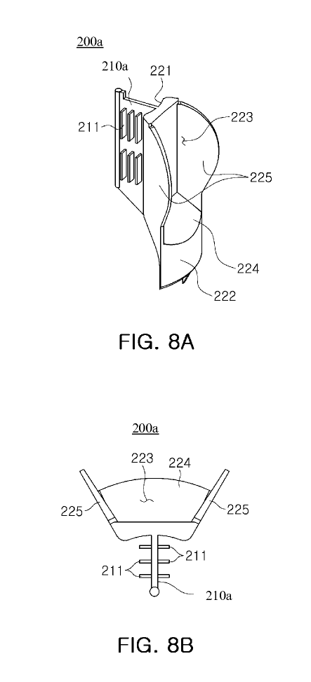

Another exemplary embodiment of the light source module will be described with reference to FIGS. 8A and 8B. A basic structure of the light source module illustrated in FIGS. 8A and 8B can be substantially the same as that of the light source modules illustrated in FIGS. 1 through 6.

As illustrated in FIGS. 8A and 8B, a light source module 200a may include a frame 220 having a slider 210a formed on the first surface 221 and a recess 223 provided in a second surface 222, a light source 230 placed on a bottom surface of the recess 223, and a cover 240 covering the light source 230.

The structures of the frame 220, the light source 230, and the cover 240 are the same as those of the frame, light source, and cover illustrated in FIG. 2, so a description thereof will be omitted.

As illustrated in FIGS. 8A and 8B, the slider 210a may vertically extend from the center of the first surface 221 of the frame 220 in the length direction of the fixing unit 110. A set of protrusions 211 may be formed on both sides of the slider 210a.

The set of protrusions 211 may be exposed within the flow paths F to increase a contact area with air that passes through the flow paths F of the slider 210a. Thus, a greater amount of heat may be dissipated through air, enhancing heat dissipation efficiency.

Hereinafter, various substrate (i.e., board) structures that may be employed in the light source 230 as described above will be described.

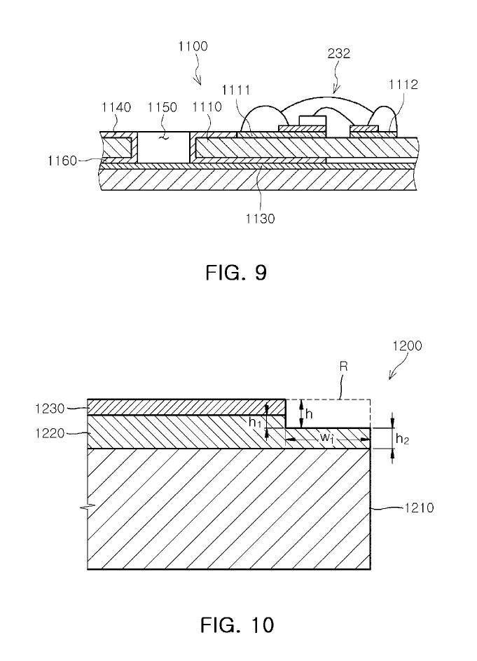

As illustrated in FIG. 9, a substrate (or a board) 1100 may include an insulating substrate 1110 including predetermined circuit patterns 1111 and 1112 formed on one surface thereof, an upper thermal diffusion plate 1140 formed on the insulating substrate 1110 such that the upper thermal diffusion plate 1140 can be in contact with the circuit patterns 1111 and 1112, and dissipating heat generated by the light emitting device 232, and a lower thermal diffusion plate 1160 formed on the other surface of the insulating substrate 1110 and transmitting heat, transmitted from the upper thermal diffusion plate 1140, outwardly. The upper thermal diffusion plate 1140 and the lower thermal diffusion plate 1160 may be connected by at least one through hole 1150 that penetrates through the insulating layer 1110 and has plated inner walls, so as to be conduct heat therebetween.

In the insulating substrate 1110, the circuit patterns 1111 and 1112 may be formed by cladding a ceramic or epoxy resin-based FR4 core with copper and performing an etching process thereon. An insulating thin film 1130 may be formed by coating an insulating material on a lower surface of the substrate 1110.

FIG. 10 illustrates another example of a substrate. As illustrated in FIG. 10, a substrate 1200 includes a first metal layer 1210, an insulating layer 1220 formed on the first metal layer 1210, and a second metal layer 1230 formed on the insulating layer 1220. A step region ‘R’ allowing the insulating layer 1220 to be exposed may be formed in at least one end portion of the substrate 1200.

The first metal layer 1210 may be made of a material having excellent exothermic characteristics. For example, the first metal layer 1210 may be made of a metal such as aluminum (Al), iron (Fe), or the like, or an alloy thereof. The first metal layer 1210 may have a unilayer structure or a multilayer structure. The insulating layer 1220 may basically be made of a material having insulating properties, and may be formed with an inorganic material or an organic material. For example, the insulating layer 1220 may be made of an epoxy-based insulating resin, and may include metal powder such as aluminum (Al) powder, or the like, in order to enhance thermal conductivity. The second metal layer 1230 may generally be formed of a copper (Cu) thin film.

As illustrated in FIG. 10, in the metal substrate according to the present exemplary embodiment, a length of an exposed region at one end portion of the insulating layer 1220, i.e., an insulation length, may be greater than a thickness of the insulating layer 1220. In the present exemplary embodiment, the insulation length refers to a length of the exposed region of the insulating layer 1220 between the first metal layer 1210 and the second metal layer 1230. When the metal substrate 1200 is viewed from above, a width of the exposed region of the insulating layer 1220 can be an exposure width W1. The region ‘R’ in FIG. 10 can be removed through a grinding process, or the like, during the manufacturing process of the metal substrate. The region as deep as a depth ‘h’ downwardly from a surface of the second metal layer 1230 can be removed to expose the insulating layer 1220 by the exposure width W1, forming a step structure. If the end portion of the metal substrate 1200 is not removed, the insulation length may be equal to a thickness (h1+h2) of the insulating layer 1220, and by removing a portion of the end portion of the metal substrate 1200, an insulation length equal to approximately W1 may be additionally secured. Thus, when a withstand voltage of the metal substrate 1200 is tested, the likelihood of contact between the two metal layers 1210 and 1230 in the end portions thereof may be minimized.

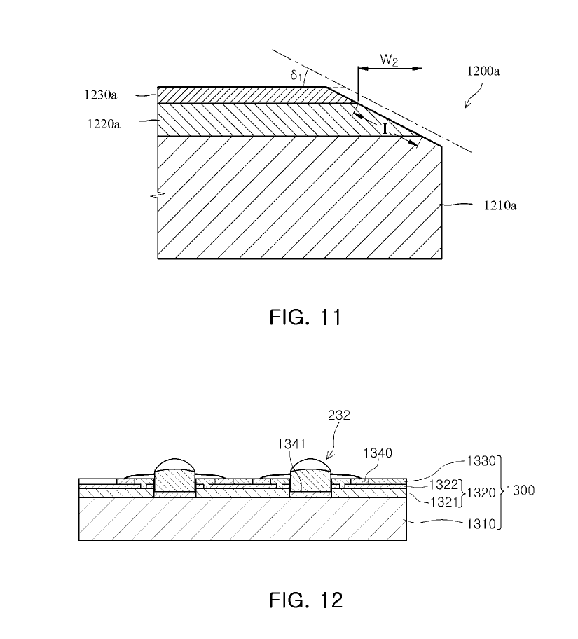

FIG. 11 is a view schematically illustrating a structure of a metal substrate according to a modification of FIG. 10. Referring to FIG. 11, a metal substrate 1200a includes a first metal layer 1210a, an insulating layer 1220a formed on the first insulating layer 1220a, and a second metal layer 1230a formed on the insulating layer 1220a. The insulating layer 1220a and the second metal layer 1230a include regions removed at a predetermined tilt angle δ1, and the first metal layer 1210a may also include a region removed at the predetermined tilt angle δ1.

Here, the tilt angle δ1 may be an angle between an interface between the insulating layer 1220a and the second metal layer 1230a and an end portion of the insulating layer 1220a. The tilt angle δ1 may be selected to secure a desired insulation length I in consideration of a thickness of the insulating layer 1220a. The tile angle δ1 may be selected from within the range of 0<δ1<90 (degrees). As the tilt angle δ1 is increased, the insulation length I and a width W2 of the exposed region of the insulating layer 1220a is increased, so in order to secure a larger insulation length, the tilt angle δ1 may be selected to be smaller. For example, the tilt angle may be selected from within the range of 0<δ1≦45 (degrees).

FIG. 12 schematically illustrates another example of a substrate. Referring to FIG. 12, a substrate 1300 includes a metal support substrate 1310 and resin-coated copper (RCC) 1320 formed on the metal support substrate 1310. The RCC 1320 may include an insulating layer 1321 and a copper foil 1322 laminated on the insulating layer 1321. A portion of the RCC 1320 may be removed to form at least one recess in which the light emitting device 232 may be installed. The metal substrate 1300 has a structure in which the RCC 1320 is removed from a lower region of the light emitting device 232 and the light emitting device 232 is in direct contact with the metal support substrate 1310. Thus, heat generated by the light emitting device 232 can be directly transmitted to the metal support substrate 1310, enhancing heat dissipation performance. The light emitting device 232 may be electrically connected to be fixed through solders 1340 and 1341. A protective layer 1330 made of a liquid photo solder resist (PSR) may be formed on an upper portion of the copper foil 1322.

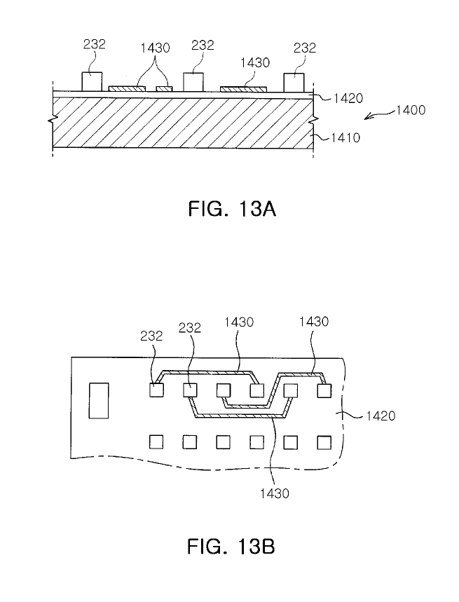

FIGS. 13A and 13B schematically illustrate another example of the substrate. A substrate according to the present exemplary embodiment includes an anodized metal substrate having excellent heat dissipation characteristics and incurring low manufacturing costs. Referring to FIGS. 13A and 13B, the anodized metal substrate 1400 may include a metal plate 1410, an anodic oxide film 1420 formed on the metal plate 1410, and electrical wirings 1430 formed on the anodic oxide film 1420.

The metal plate 1410 may be made of aluminum (Al) or an Al alloy that may be easily obtained at low cost. Besides, the metal plate 1410 may be made of any other anodizable metal, for example, a material such as titanium (Ti), magnesium (Mg), or the like.

Aluminum oxide film (Al₂O₃) 1420 obtained by anodizing aluminum has a relatively high heat transmission characteristics ranging from about 10 Watts per meter Kelvin (W/mK) to 30 W/mK. Thus, the anodized metal substrate 1400 has superior heat dissipation characteristics to those of a PCB, an MCPCB, or the like, conventional polymer substrates.

Aluminum oxide film (Al₂O₃) 1420 obtained by anodizing aluminum has a relatively high heat transmission characteristics ranging from about 10 W/mK to 30 W/mK. Thus, the anodized metal substrate 1400 has superior heat dissipation characteristics to those of a PCB, an MCPCB, or the like, conventional polymer substrates.

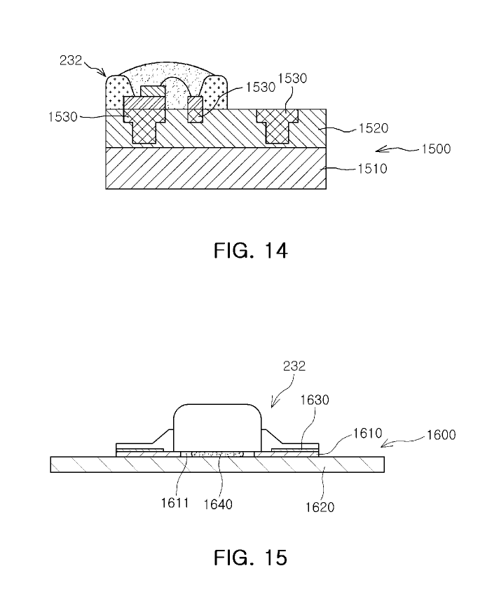

FIG. 14 schematically illustrates another example of the substrate. As illustrated in FIG. 14, a substrate 1500 may include a metal substrate 1510, an insulating resin 1520 coated on the metal substrate 1510, and a circuit pattern 1530 formed on the insulating resin 1520. Here, the insulating resin 1520 may have a thickness equal to or less than 200 μm. The insulating resin 1520 may be laminated on the metal substrate 1510 in the form of a solid film or may be coated in liquid form using spin coating or a blade. Also, the circuit pattern 1530 may be formed by filling a metal such as copper (Cu), or the like, in a circuit pattern intaglioed on the insulting layer 1520. The light emitting device 232 may be mounted to be electrically connected to the circuit pattern 1530.

Meanwhile, the substrate may include a flexible PCB (FPCB) that can be freely deformed. As illustrated in FIG. 15, a substrate 1600 includes a flexible circuit board 1610 having one or more through holes 1611, and a support substrate 1620 on which the flexible circuit board 1610 is mounted. A heat dissipation adhesive 1640 may be provided in the through hole 1611 to couple a lower surface of the light emitting device 232 and an upper surface of the support substrate 1620. Here, the lower surface of the light emitting device 232 may be a lower surface of a chip package, a lower surface of a lead frame having an upper surface on which a chip is mounted, or a metal block. A circuit wiring 1630 can be formed on the flexible circuit board 1610 and electrically connected to the light emitting device 232.

In this manner, since the flexible circuit board 1610 can be used, thickness and weight can be reduced, obtaining reduced thickness and weight and reducing manufacturing costs, and since the light emitting device 232 can be directly bonded to the support substrate 1620 by the heat dissipation adhesive 1640, heat dissipation efficiency in dissipating heat generated by the light emitting device 232 can be increased.

The foregoing substrate may have a flat plate shape. However, a size and a structure of the substrate may be variously modified according to a structure of a device, e.g., a lighting device, in which the light source module is used.

Hereinafter, various LED packages and various LED chips that may be employed as the light emitting devices of the light sources as described above will be described.

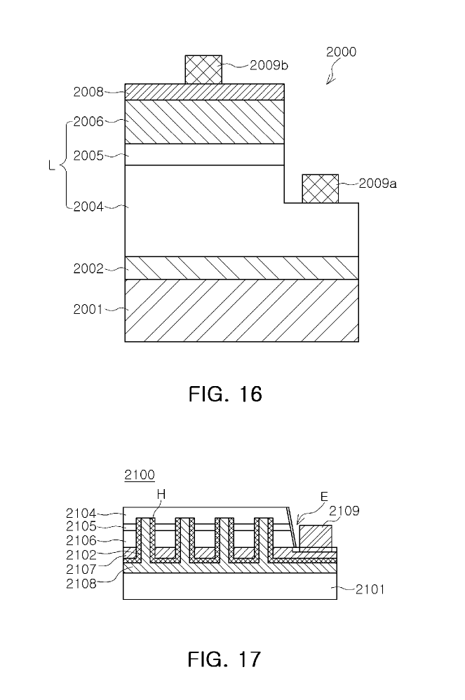

FIG. 16 is a side cross-sectional view schematically illustrating an example of a light emitting device as an LED chip.

As illustrated in FIG. 16, a light emitting device 2000 (similar to the light emitting device 232 of FIG. 15) may include a light emitting laminate L formed on a growth substrate 2001. The light emitting laminate L may include a first conductivity-type semiconductor layer 2004, an active layer 2005, and a second conductivity-type semiconductor layer 2006.

An ohmic-contact layer 2008 may be formed on the second conductivity-type semiconductor layer 2006, and first and second electrodes 2009a and 2009b may be formed on upper surfaces of the first conductivity-type semiconductor layer 2004 and the ohmic-contact layer 2008, respectively.

In the present disclosure, terms such as ‘upper portion’, ‘upper surface’, ‘lower portion’, ‘lower surface’, ‘lateral surface’, and the like, are determined based on the drawings, and in actuality, the terms may be changed according to a direction in which a light emitting device is disposed.

Hereinafter, major components of the light emitting device will be described.

A substrate constituting a light emitting device can be a growth substrate for epitaxial growth. As the substrate 2001, an insulating substrate, a conductive substrate, or a semiconductor substrate may be used as necessary. For example, sapphire, SiC, Si, MgAl₂O₄, MgO, LiAlO₂, LiGaO₂, or Gallium Nitride (GaN) may be used as a material of the substrate 2001. For epitaxial growth of a GaN material, a GaN substrate, a homogeneous substrate, may be desirable, but it incurs high production costs due to difficulties in the manufacturing thereof.

As a heterogeneous substrate, a sapphire substrate, a silicon carbide substrate, or the like, is largely used, and in this case, a sapphire substrate can be utilized relatively more than the costly silicon carbide substrate. When a heterogeneous substrate is used, defects such as dislocation, and the like, are increased due to differences in lattice constants between a substrate material and a thin film material. Also, differences in coefficients of thermal expansion between the substrate material and the thin film material may cause bowing due to changing temperatures, and the bowing may cause cracks in the thin film. This problem may be reduced by using a buffer layer 2002 between the substrate 2001 and the light emitting laminate L based on GaN.

The substrate 2001 may be fully or partially removed or patterned during a chip manufacturing process in order to enhance optical or electrical characteristics of the LED chip before or after the light emitting laminate L is grown.

For example, a sapphire substrate may be separated by irradiating a laser on the interface between the substrate and a semiconductor layer through the substrate, and a silicon substrate or a silicon carbide substrate may be removed through a method such as polishing, etching, or the like.

In removing the substrate, a support substrate may be used, and in this case, in order to enhance luminance efficiency of an LED chip on the opposite side of the original growth substrate, the support substrate may be bonded by using a reflective metal or a reflective structure may be inserted into the center of a junction layer.

Substrate patterning forms a concavo-convex surface or a sloped surface on a main surface (one surface or both surfaces) or lateral surfaces of a substrate before or after the growth of the light emitting laminate S, enhancing light extraction efficiency. A pattern size may be selected within the range from 5 nm to 500 μm. The substrate may have any structure as long as it has a regular or irregular pattern to enhance light extraction efficiency. The substrate may have various shapes such as a columnar shape, a peaked shape, a hemispherical shape, a polygonal shape, and the like.

Here, the sapphire substrate can be a crystal having Hexa-Rhombo R3c symmetry, of which lattice constants in c-axial and a-axial directions are approximately 13.001 Å (Angstrom) and 4.758 Å, respectively, and has a C-plane (0001), an A-plane (1120), an R-plane (1102), and the like. In this case, the C-plane of sapphire crystal allows a nitride thin film to be relatively easily grown thereon and is stable at high temperatures, so the sapphire substrate can be commonly used as a nitride growth substrate.

The substrate 2001 may also be made of silicon (Si). Since a silicon (Si) substrate can be more appropriate for increasing a diameter and is relatively low in price, it may be used to facilitate mass-production. Here, a difference in lattice constants between the silicon substrate having (111) plane as a substrate surface and GaN can be approximately 17%, requiring a technique of suppressing the generation of crystal defects due to the difference between the lattice constants is required. Also, a difference in coefficients of thermal expansion between silicon and GaN can be approximately 56%, requiring a technique of suppressing bowing of a wafer generated due to the difference in the coefficients of thermal expansion. Bowed wafers may result in cracks in the GaN thin film and make it difficult to control processes to increase dispersion of emission wavelengths (or excitation wavelengths) of light in the same wafer, or the like.

The silicon substrate absorbs light generated in the GaN-based semiconductor, lowering external quantum yield of the light emitting device. Thus, the substrate may be removed and a support substrate such as a silicon substrate, a germanium substrate, a SiAl substrate, a ceramic substrate, a metal substrate, or the like, including a reflective layer may be additionally formed to be used, as necessary.

When a GaN thin film is grown on a heterogeneous substrate such as the silicon substrate, dislocation density may be increased due to a lattice constant mismatch between a substrate material and a thin film material, and cracks and warpage (or bowing) may be generated due to a difference between coefficients of thermal expansion. In order to prevent dislocation of and cracks in the light emitting laminate S, the buffer layer 2002 may be disposed between the substrate 1001 and the light emitting laminate S. The buffer layer 1002 may serve to adjust a degree of warpage of the substrate when an active layer is grown, to reduce a wavelength dispersion of a wafer.

The buffer layer 2002 may be made of AlₓIn_{y}Ga_{1-x-y}N (0≦x≦1, 0≦y≦1), in particular, GaN, AlN, AlGaN, InGaN, or InGaNAlN, and a material such as ZrB₂, HfB₂, ZrN, HfN, TiN, or the like, may also be used as necessary. Also, the buffer layer may be formed by combining a set of layers or by gradually changing a composition.

A silicon (Si) substrate has a coefficient of thermal expansion significantly different from that of GaN. Thus, in the case of growing a GaN-based thin film on the silicon substrate, when a GaN thin film is grown at a high temperature and is subsequently cooled to room temperature, tensile stress can be applied to the GaN thin film due to the difference in the coefficients of thermal expansion between the silicon substrate and the GaN thin film, generating cracks. In this case, in order to prevent the generation of cracks, a method of growing the GaN thin film such that compressive stress is applied to the GaN thin film while the GaN thin film is being grown can be used to compensate for tensile stress.

A difference in the lattice constants between silicon (Si) and GaN involves a high possibility of a defect being generated therein. In the case of a silicon substrate, a buffer layer having a composite structure may be used in order to control stress for restraining warpage (or bowing) as well as controlling a defect.

For example, first, an AlN layer can be formed on the substrate 2001. In this case, a material not including gallium (Ga) may be used in order to prevent a reaction between silicon (Si) and gallium (Ga). Besides AlN, a material such as SiC, or the like, may also be used. The AlN layer can be grown at a temperature ranging from 400° C. to 1,300° C. by using an aluminum (Al) source and a nitrogen (N) source. An AlGaN intermediate layer may be inserted into the center of GaN between the set of AlN layers to control stress, as necessary.

The light emitting laminate L having a multilayer structure of a Group III nitride semiconductor will be described in detail. The first and second conductivity-type semiconductor layers 2004 and 2006 may be formed of n-type and p-type impurity-doped semiconductor materials, respectively.

However, the present disclosure is not limited thereto and, conversely, the first and second conductivity-type semiconductor layers 2004 and 2006 may be formed of p-type and n-type impurity-doped semiconductor materials, respectively. For example, the first and second conductivity-type semiconductor layers 2004 and 2006 may be made of a Group III nitride semiconductor, e.g., a material having a composition of AlₓIn_{y}Ga_{1-x-y}N (0≦x≦1, 0≦y≦1, 0≦x+y≦1). Of course, the present disclosure is not limited thereto and the first and second conductivity-type semiconductor layers 2004 and 2006 may also be made of a material such as an AlGaInP-based semiconductor or an AlGaAs-based semiconductor.

Meanwhile, the first and second conductivity-type semiconductor layers 2004 and 2006 may have a unilayer structure, or, alternatively, the first and second conductivity-type semiconductor layers 2004 and 2006 may have a multilayer structure including layers having different compositions, thicknesses, and the like, as necessary. For example, the first and second conductivity-type semiconductor layers 2004 and 2006 may have a carrier injection layer for improving electron and hole injection efficiency, or may have various types of superlattice structure, respectively.

The first conductivity-type semiconductor layer 2004 may further include a current spreading layer (not shown) in a region adjacent to the active layer 2005. The current spreading layer may have a structure in which a set of InₓAl_{y}Ga_{(1-x-y)}N layers having different compositions or different impurity contents are iteratively laminated or may have an insulating material layer partially formed therein.

The second conductivity-type semiconductor layer 2006 may further include an electron blocking layer in a region adjacent to the active layer 2005. The electron blocking layer may have a structure in which a set of InₓAl_{y}Ga_{(1-x-y)}N layers having different compositions are laminated or may have one or more layers including Al_{y}Ga_{(1-y)}N. The electron blocking layer has a bandgap wider than that of the active layer 2005, thus preventing electrons from being transferred via the second conductivity-type (p-type) semiconductor layer 2006.

The light emitting laminate L may be formed by using metal-organic chemical vapor deposition (MOCVD). In order to fabricate the light emitting laminate S, an organic metal compound gas (e.g., trimethyl gallium (TMG), trimethyl aluminum (TMA)) and a nitrogen-containing gas (ammonia (NH₃), or the like) are supplied to a reaction container in which the substrate 2001 is installed as reactive gases, the substrate being maintained at a high temperature ranging from 900° C. to 1,100° C., and while a gallium nitride (GaN)-based compound semiconductor is being grown, an impurity gas can be supplied as necessary to laminate the gallium nitride-based compound semiconductor as an undoped n-type or p-type semiconductor. Silicon (Si) is a well known n-type impurity and p-type impurity includes zinc (Zn), cadmium (Cd), beryllium (Be), magnesium (Mg), calcium (Ca), barium (Ba), and the like. Among these, magnesium (Mg) and zinc (Zn) may be mainly used.

Also, the active layer 2005 disposed between the first and second conductivity-type semiconductor layers 2004 and 2006 may have a multi-quantum well (MQW) structure in which a quantum well layer and a quantum barrier layer are alternately laminated. For example, in the case of a nitride semiconductor, a GaN/InGaN structure may be used, or a single quantum well (SQW) structure may also be used.

The ohmic-contact layer 2008 may have a relatively high impurity concentration to have low ohmic-contact resistance to lower an operating voltage of the element and enhance element characteristics. The ohmic-contact layer 2008 may be formed of a GaN layer, a InGaN layer, a ZnO layer, or a graphene layer.

The first or second electrode 2009a or 2009b may be made of a material such as silver (Ag), nickel (Ni), aluminum (Al), rhodium (Rh), palladium (Pd), iridium (Ir), ruthenium (Ru), magnesium (Mg), zinc (Zn), platinum (Pt), gold (Au), or the like, and may have a structure including two or more layers such as Ni/Ag, Zn/Ag, Ni/Al, Zn/Al, Pd/Ag, Pd/Al, Ir/Ag. Ir/Au, Pt/Ag, Pt/Al, Ni/Ag/Pt, or the like.

The LED chip illustrated in FIG. 16 has a structure in which first and second electrodes face the same surface as a light extraction surface, but it may also be implemented to have various other structures, such as a flipchip structure in which first and second electrodes face a surface opposite to a light extraction surface, a vertical structure in which first and second electrodes are formed on mutually opposing surfaces, a vertical and horizontal structure employing an electrode structure by forming several vias in a chip as a structure for enhancing current spreading efficiency and heat dissipation efficiency, and the like.

In case of manufacturing a large light emitting device for a high output, an LED chip illustrated in FIG. 17 having a structure promoting current spreading efficiency and heat dissipation efficiency may be provided.

FIG. 17 is an example of a light emitting device as an LED chip. As illustrated in FIG. 17, the LED chip 2100 may include a first conductivity-type semiconductor layer 2104, an active layer 2105, a second conductivity-type semiconductor layer 2106, a second electrode layer 2107, an insulating layer 2102, a first electrode 2108, and a substrate 2101, laminated sequentially. Here, in order to be electrically connected to the first conductivity-type semiconductor layer 2104, the first electrode layer 2108 includes one or more contact holes H extending from one surface of the first electrode layer 2108 to at least a partial region of the first conductivity-type semiconductor layer 2104 and electrically insulated from the second conductivity-type semiconductor layer 2106 and the active layer 2105. However, the first electrode layer 2108 is not an essential element in the present exemplary embodiment.

The contact hole H extends from an interface of the first electrode layer 2108, passing through the second electrode layer 2107, the second conductivity-type semiconductor layer 2106, and the first active layer 2105, to the interior of the first conductivity-type semiconductor layer 2104. The contact hole H extends at least to an interface between the active layer 2105 and the first conductivity-type semiconductor layer 2104, and preferably, extends to a portion of the first conductivity-type semiconductor layer 2104. However, the contact hole H can be formed for electrical connectivity and current spreading, so the purpose of the presence of the contact hole H is achieved when it is in contact with the first conductivity-type semiconductor layer 2104. Thus, it is not necessary for the contact hole H to extend to an external surface of the first conductivity-type semiconductor layer 2104.

The second electrode layer 2107 formed on the second conductivity-type semiconductor layer 2106 may be selectively made of a material among silver (Ag), nickel (Ni), aluminum (Al), rhodium (Rh), palladium (Pd), iridium (Ir), ruthenium (Ru), magnesium (Mg), zinc (Zn), platinum (Pt), gold (Au), and the like, in consideration of a light reflecting function and an ohmic-contact function with the second conductivity-type semiconductor layer 2106, and may be formed by using a process such as sputtering, deposition, or the like.

The contact hole H may have a form penetrating the second electrode layer 2107, the second conductivity-type semiconductor layer 2106, and the active layer 2105 so as to be connected to the first conductivity-type semiconductor layer 2104. The contact hole H may be formed through an etching process, e.g., inductively coupled plasma-reactive ion etching (ICP-RIE), or the like.

The insulating layer 2102 can be formed to cover a side wall of the contact hole H and a lower surface of the second electrode layer 2107. In this case, at least a portion of the first conductivity-type semiconductor layer 2104 may be exposed by the contact hole H. The insulating layer 2102 may be formed by depositing an insulating material such as SiO₂, SiOₓN_{y}, or SiₓN_{y}. The insulating layer 2102 may be deposited to have a thickness ranging from about 0.01 μm to 3 μm at a temperature equal to or lower than 500° C. through a chemical vapor deposition (CVD) process.

The first electrode layer 2108 including a conductive via formed by filling a conductive material can be formed within the contact hole H. A set of conductive vias may be formed in a single light emitting device region. The amount of vias and contact areas thereof may be adjusted such that the area of the set of vias occupying on the plane of the regions in which they are in contact with the first conductivity-type semiconductor layer 2104 ranges from 1% to 5% of the area of the light emitting device region. A radius of the via on the plane of the region in which the vias are in contact with the first conductivity-type semiconductor layer 2104 may range, for example, from 5 μm to 50 μm, and the number of vias may be 1 to 50 per light emitting device region according to a width of the light emitting device region. Although different according to a width of the light emitting device region, three or more vias may be provided. A distance between the vias may range from 100 μm to 500 μm, and the vias may have a matrix structure including rows and columns. Preferably, the distance between the vias may range from 150 μm to 450 μm. If the distance between the vias is smaller than 100 μm, the amount of vias can be increased to relatively reduce a light emitting area to lower luminous efficiency, and if the distance between the vias is greater than 500 μm, current spreading may suffer to degrade luminous efficiency. A depth of the contact hole H may range from 0.5 μm to 5.0 μm, although the depth of the contact hole H V may vary according to a thickness of the second conductivity-type semiconductor layer and the active layer.

Subsequently, the substrate 2101 can be formed on the first electrode layer 2108. In this structure, the substrate 2101 may be electrically connected by the conductive via connected to the first conductivity-type semiconductor layer 2104.

The substrate 2101 may be made of a material including any one of gold (Au), nickel (Ni), aluminum (Al), copper (Cu), tungsten (W), silicon (Si), Se, GaAs, SiAl, Ge, SiC, AlN, Al₂O₃, GaN, AlGaN and may be formed through a process such as plating, sputtering, deposition, bonding, or the like.

In order to reduce contact resistance, the amount, a shape, a pitch, a contact area with the first and second conductivity-type semiconductor layers 2104 and 2106, and the like, of the contact hole H may be appropriately regulated. The contact holes H may be arranged to have various shapes in rows and columns to improve a current flow. Here, the second electrode layer 2107 may have one or more exposed regions in the interface between the second electrode layer 2017 and the second conductivity-type semiconductor layer 2106, i.e., an exposed region E. An electrode pad part 2109 connecting an external power source to the second electrode layer 2107 may be provided on the exposed region E.

In this manner, the LED chip 2100 illustrated in FIG. 17 may include the light emitting structure having the first and second main surfaces opposing one another and having the first and second conductivity-type semiconductor layers 2104 and 2106 providing the first and second main surfaces, respectively, and the active layer 2105 formed therebetween, the contact holes H connected to a region of the first conductivity-type semiconductor layer 2104 through the active layer 2105 from the second main surface, the first electrode layer 2108 formed on the second main surface of the light emitting structure and connected to a region of the first conductivity-type semiconductor layer 2104 through the contact holes H, and the second electrode layer 2107 formed on the second main surface of the light emitting structure and connected to the second conductivity-type semiconductor layer 2106. Here, any one of the first and second electrodes 2108 and 2107 may be drawn out in a lateral direction of the light emitting structure.

A lighting device using an LED provides improved heat dissipation characteristics, but in the aspect of overall heat dissipation performance, preferably, the lighting device employs an LED chip having a low heating value. As an LED chip satisfying such requirements, an LED chip including a nano-structure (hereinafter, referred to as a ‘nano-LED chip’) may be used.

Such a nano-LED chip includes a recently developed core/shell type nano-LED chip, which has a low binding density to generate a relatively low degree of heat, has increased luminous efficiency by increasing a light emitting region by utilizing nano-structures, and prevents a degradation of efficiency due to polarization by obtaining a non-polar active layer, thus improving drop characteristics.

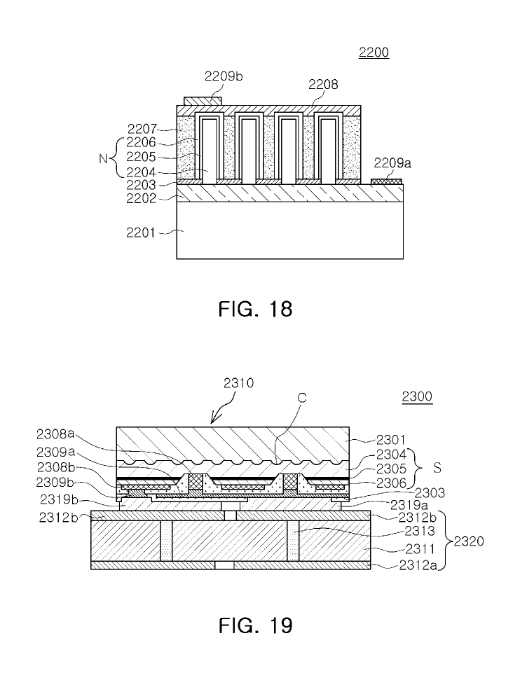

FIG. 18 is a cross-sectional view illustrating a nano-LED chip as another example of an LED chip that may be employed in a light source module.

As illustrated in FIG. 18, a nano-LED chip 2200 includes a set of nano-light emitting structures N formed on a substrate 2201. In this example, it is illustrated that the nano-light emitting structures N have a core-shell structure as a rod structure, but the present disclosure is not limited thereto and the nano-light emitting structures N may have a different structure such as a pyramid structure.

The nano-LED chip 2200 includes a base layer 2202 formed on the substrate 2201. The base layer 2202 is a layer providing a growth surface for the nano-light emitting structure, which may be a first conductivity-type semiconductor layer. A mask layer 2203 having an open area for the growth of the nano-light emitting structures N (in particular, the core) may be formed on the base layer 2202. The mask layer 2203 may be made of a dielectric material such as SiO₂ or SiNx.

In the nano-light emitting structures N, a first conductivity-type nano-core 2204 can be formed by selectively growing a first conductivity-type semiconductor by using the mask layer 2203 having an open area, and an active layer 2205 and a second conductivity-type semiconductor layer 2206 are formed as shell layers on a surface of the nano-core 2204. Accordingly, the nano-light emitting structures N may have a core-shell structure in which the first conductivity-type semiconductor is the nano-core and the active layer 2205 and the second conductivity-type semiconductor layer 2206 enclosing the nano-core are shell layers.

The nano-LED chip 2200 according to the present example includes a filler material 2207 filling spaces between the nano-light emitting structures N. The filler material 2207 may structurally stabilize the nano-light emitting structures N and may be employed as necessary in order to optically improve the nano-light emitting structures N. The filler material 2207 may be made of a transparent material such as SiO₂, or the like, but the present disclosure is not limited thereto. An ohmic-contact layer 2208 may be formed on the nano-light emitting structures and connected to the second conductivity-type semiconductor layer 2206. The nano-LED chip 2200 includes first and second electrodes 2209a and 2209b connected to the base layer 2202 formed of the first conductivity-type semiconductor and the ohmic-contact layer 2208, respectively.

By forming the nano-light emitting structures such that they have different diameters, components, and doping densities, light having two or more different wavelengths may be emitted from the single device. By appropriately adjusting light having different wavelengths, white light may be implemented without using phosphors in the single device, and light having various desired colors or white light having different color temperatures may be implemented by combining a different LED chip with the foregoing device or combining wavelength conversion materials such as phosphors.

FIG. 19 illustrates a semiconductor light emitting device 2300 having an LED chip 2310 mounted on a mounting substrate 2320 as a light source that may be employed in the foregoing lighting device.

The semiconductor light emitting device 2300 illustrated in FIG. 19 includes an LED chip 2310 mounted on a mounting substrate 2320. The LED chip 2310 can be presented as an LED chip different from that of the example described above.

The LED chip 2310 includes a light emitting laminate S disposed in one surface of the substrate 2301 and first and second electrodes 2308a and 2308b disposed on the opposite side of the substrate 2301 based on the light emitting laminate S. Also, the LED chip 2310 includes an insulating part 2303 covering the first and second electrodes 2308a and 2308b.

The first and second electrodes 2308a and 2308b may include first and second electrode pads 2319a and 2319b connected thereto by electrical connection parts 2309a and 2309b.

The light emitting laminate S may include a first conductivity-type semiconductor layer 2304, an active layer 2305, and a second conductivity-type semiconductor layer 2306. The first electrode 2308a may be provided as a conductive via connected to the first conductivity-type semiconductor layer 2304 through the second conductivity-type semiconductor layer 2306 and the active layer 2305. The second electrode 2308b may be connected to the second conductivity-type semiconductor layer 2306.

A set of conductive vias may be formed in a single light emitting device region. The amount of vias and contact areas thereof may be adjusted such that the area the set of vias occupy on the plane of the regions in which they are in contact with the first conductivity-type semiconductor layer 2104 ranges from 1% to 5% of the area of the light emitting device region. A radius of the via on the plane of the regions in which the vias are in contact with the first conductivity-type semiconductor layer 2304 may range, for example, from 5 μm to 50 μm, and the number of vias may be 1 to 50 per light emitting device region according to a width of the light emitting device region. Although different according to a width of the light emitting device region, three or more vias may be provided. A distance between the vias may range from 100 μm to 500 μm, and the vias may have a matrix structure including rows and columns. Preferably, the distance between the vias may range from 150 μm to 450 μm. If the distance between the vias is smaller than 100 μm, the amount of vias can be increased to relatively reduce a light emitting area to lower luminous efficiency, and if the distance between the vias is greater than 500 μm, current spreading may suffer to degrade luminous efficiency. A depth of the vias may range from 0.5 μm to 5.0 μm, although it may vary according to a thickness of the second conductivity-type semiconductor layer 2306 and the active layer 2305.

The first and second electrodes 2308a and 2308b are formed by depositing a conductive ohmic material on the light emitting laminate S. The first and second electrodes 2308a and 2308b may include at least one of silver (Ag), aluminum (Al), nickel (Ni), chromium (Cr), copper (Cu), gold (Au), palladium (Pd), platinum (Pt), tin (Sn), titanium (Ti), tungsten (W), rhodium (Rh), iridium (Ir), ruthenium (Ru), magnesium (Mg), zinc (Zn), and an alloy material thereof. For example, the second electrode 2308b may be an ohmic electrode of a silver (Ag) layer laminated on the basis of the second conductivity-type semiconductor layer 2306. The Ag ohmic electrode may serve as a reflective layer of light. A single layer of nickel (Ni), titanium (Ti), platinum (Pt), tungsten (W), or an alloy layer thereof may be alternatively laminated on the Ag layer. In detail, an Ni/Ti layer, a TiW/Pt layer, or a Ti/W layer may be laminated on an Ag layer, or these layers may be alternately laminated on the Ag layer.

As the first electrode 2308a, on the basis of the first conductivity-type semiconductor layer 2304, a Cr layer may be laminated and Au/Pt/Ti layers may be sequentially laminated on the Cr layer, or on the basis of the second conductivity-type semiconductor layer 2306, an Al layer can be laminated and Ti/Ni/Au layers may be sequentially laminated on the Al layer. The first and second electrodes 2308a and 2308b may be made of various other materials or may have various other lamination structures in order to enhance ohmic characteristics or reflecting characteristics.

The insulating part 2303 may have an open area exposing at least portions of the first and second electrodes 2308a and 2308b, and the first and second electrode pads 2319a and 2319b may be connected to the first and second electrodes 2308a and 2308b. The insulating part 2303 may be deposited to have a thickness ranging from 0.01 μm to 3 μm at a temperature equal to or lower than 500° C. through an SIO₂ and/or SiN chemical vapor deposition (CVD) process.

The first and second electrodes 2308a and 2308b may be disposed in the same direction and may be mounted as a so-called flip-chip on a lead frame, or the like, as described hereinafter.

In particular, the first electrode 2308a may be connected to the first electrical connection part 2309a having a conductive via connected to the first conductivity-type semiconductor layer 2304 by passing through the second conductivity-type semiconductor layer 2306 and the active layer 2305 within the light emitting laminate S.

The amount, a shape, a pitch, a contact area with the first conductivity-type semiconductor layer 2304, and the like, of the conductive via and the first electrical connection part 2309a may be appropriately regulated in order to lower contact resistance, and the conductive via and the first electrical connection part 2309a may be arranged in a row and in a column to improve current flow.

Another electrode structure may include the second electrode 2308b directly formed on the second conductivity-type semiconductor layer 2306 and the second electrical connection portion 2309b formed on the second electrode 2308b. In addition to having a function of forming electrical-ohmic connection with the second conductivity-type semiconductor layer 2306, the second electrode 2308b may be made of a light reflective material, whereby, as illustrated in FIG. 19, in a state in which the LED chip 2310 is mounted as a so-called flip chip structure, light emitted from the active layer 2305 can be effectively emitted in a direction of the substrate 2301. Of course, the second electrode 2308b may be made of a light-transmissive conductive material such as a transparent conductive oxide, according to a main light emitting direction.

The two electrode structures as described above may be electrically separated by the insulating part 2303. The insulating part 2303 may be made of any material as long as it has electrically insulating properties. Namely, the insulating part 2303 may be made of any material having electrically insulating properties, and here, preferably, a material having a low degree of light absorption is used. For example, a silicon oxide or a silicon nitride such as SiO₂, SiOₓN_{y}, SiₓN_{y}, or the like, may be used. If necessary, a light reflective filler may be dispersed within the light-transmissive material to form a light reflective structure.

The first and second electrode pads 2319a and 2319b may be connected to the first and second electrical connection parts 2309a and 2309b to serve as external terminals of the LED chip 2310, respectively. For example, the first and second electrode pads 2319a and 2319b may be made of gold (Au), silver (Ag), aluminum (Al), titanium (Ti), tungsten (W), copper (Cu), tin (Sn), nickel (Ni), platinum (Pt), chromium (Cr), NiSn, TiW, AuSn, or a eutectic metal thereof. In this case, when the LED chip is mounted on the mounting substrate 1320, the first and second electrode pads 2319a and 2319b may be bonded by using the eutectic metal, so solder bumps generally required for flip chip bonding may not be used. The use of a eutectic metal advantageously obtains superior heat dissipation effects in the mounting method in comparison to the case of using solder bumps. In this case, in order to obtain excellent heat dissipation effects, the first and second electrode pads 2319a and 2319b may be formed to occupy a relatively large area.

The substrate 2301 and the light emitting laminate S may be understood with reference to content described above with reference to FIG. 16, unless otherwise described. Also, although not shown, a buffer layer may be formed between the light emitting structure S and the substrate 2301. The buffer layer may be employed as an undoped semiconductor layer made of a nitride, or the like, to alleviate lattice defects of the light emitting structure grown thereon.

The substrate 2301 may have first and second main surfaces opposing one another, and an uneven structure (i.e., a depression and protrusion pattern) may be formed on at least one of the first and second main surfaces. The uneven structure formed on one surface of the substrate 2301 may be formed by etching a portion of the substrate 2301 so as to be made of the same material as that of the substrate 2301. Alternatively, the uneven structure may be made of a heterogeneous material different from that of the substrate 2301.

In the present exemplary embodiment, since the uneven structure can be formed on the interface between the substrate 2301 and the first conductivity-type semiconductor layer 2304, paths of light emitted from the active layer 2305 can be of diversity, and thus, a light absorption ratio of light absorbed within the semiconductor layer can be reduced and a light scattering ratio can be increased, increasing light extraction efficiency.

In detail, the uneven structure may be formed to have a regular or irregular shape. The heterogeneous material used to form the uneven structure may be a transparent conductor, a transparent insulator, or a material having excellent reflectivity. Here, as the transparent insulator, a material such as SiO2, SiNx, Al₂O₃, HfO, TiO₂, or ZrO may be used. As the transparent conductor, a transparent conductive oxide (TCO) such as ZnO, an indium oxide containing an additive (e.g., Mg, Ag, Zn, Sc, Hf, Zr, Te, Se, Ta, W, Nb, Cu, Si, Ni, Co, Mo, Cr, Sn), or the like, may be used. As the reflective material, silver (Ag), aluminum (Al), or a distributed Bragg reflector (DBR) including multiple layers having different refractive indices, may be used. However, the present disclosure is not limited thereto.

The substrate 2301 may be removed from the first conductivity-type semiconductor layer 2304. To remove the substrate 2301, a laser lift-off (LLO) process using a laser, an etching or a polishing process may be used. Also, after the substrate 2301 is removed, depressions and protrusions may be formed on the surface of the first conductivity-type semiconductor layer 1304.

As illustrated in FIG. 19, the LED chip 2310 can be mounted on the mounting substrate 2320. The mounting substrate 2320 includes upper and lower electrode layers 2312b and 2312a formed on upper and lower surfaces of the substrate body 2311, and vias 2313 penetrating through the substrate body 2311 to connect the upper and lower electrode layers 2312b and 2312a. The substrate body 2311 may be made of a resin, a ceramic, or a metal, and the upper or lower electrode layer 2312b or 2312a may be a metal layer made of gold (Au), copper (Cu), silver (Ag), or aluminum (Al).

Of course, the substrate on which the foregoing LED chip 2310 can be mounted is not limited to the configuration of the mounting substrate 2320 illustrated in FIG. 19, and any substrate having a wiring structure for driving the LED chip 2310 may be employed. For example, any one of the substrates described above with reference to FIGS. 9 through 15 may be employed, or a package structure in which an LED chip can be mounted on a package body having a pair of lead frames may be provided.

LED chips having various structures other than that of the foregoing LED chip described above may also be used. For example, an LED chip in which surface-plasmon polaritons (SPP) are formed in a metal-dielectric boundary of an LED chip to interact with quantum well excitons, thus obtaining significantly improved light extraction efficiency, may also be advantageously used.

Meanwhile, the light emitting device 232 may be configured to include at least one of a light emitting device emitting white light by combining yellow, green, red, and orange phosphors with a blue LED chip and a purple, blue, green, red, and infrared light emitting device. In this case, the light emitting device 232 may control a color rendering index (CRI) to range from a sodium-vapor (Na) lamp (40) to a sunlight level (100), or the like, and control a color temperature ranging from 2000K to 20000K level to generate various levels of white light. If necessary, the light emitting device 232 may generate visible light having purple, blue, green, red, orange colors, or infrared light to adjust an illumination color according to a surrounding atmosphere or mood. Also, the light emitting device may generate light having a special wavelength stimulating plant growth.

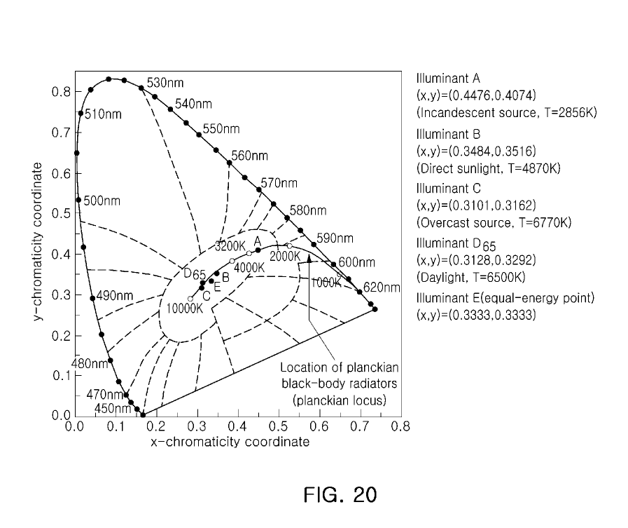

White light generated by combining yellow, green, red phosphors to a blue LED and/or combining at least one of a green LED and a red LED thereto may have two or more peak wavelengths and may be positioned in a segment linking (x, y) coordinates (0.4476, 0.4074), (0.3484, 0.3516), (0.3101, 0.3162), (0.3128, 0.3292), (0.3333, 0.3333) of a CIE 1931 chromaticity diagram illustrated in FIG. 20. Alternatively, white light may be positioned in a region surrounded by a spectrum of black body radiation and the segment. A color temperature of white light corresponds to a range from about 2000K to about 20000K.

Phosphors may have the following empirical formula and colors.
Oxide-based phosphors: Yellow and green Y3Al5O12:Ce, Tb3Al5O12:Ce, Lu3Al5O12:Ce
Silicate-based phosphors: Yellow and green (Ba,Sr)2SiO4:Eu, yellow and orange (Ba,Sr)3SiO5:Ce
Nitride-based phosphors: Green β-SiAlON:Eu, yellow L3Si6O11:Ce, orange α-SiAlON:Eu, red CaAlSiN3:Eu, Sr2Si5N8:Eu, SrSiAl4N7:Eu
Fluoride-based phosphors: KSF-based red K2SiF6:Mn4+

Phosphor compositions should be basically conformed to Stoichiometry, and respective elements may be substituted with different elements of respective groups of the periodic table. For example, strontium (Sr) may be substituted with barium (Ba), calcium (Ca), magnesium (Mg), or the like, of alkali earths, and yttrium (Y) may be substituted with terbium (Tb), Lutetium (Lu), scandium (Sc), gadolinium (Gd), or the like. Also, europium (Eu), an activator, may be substituted with cerium (Ce), terbium (Tb), praseodymium (Pr), erbium (Er), ytterbium (Yb), or the like, according to a desired energy level, and an activator may be applied alone, or a coactivator, or the like, may be additionally applied to change characteristics.

Also, materials such as quantum dots, or the like, may be applied as materials that replace phosphors, and phosphors and quantum dots may be used in combination or alone in an LED.

A quantum dot may have a structure including a core (3 nm to 10 nm) such as CdSe, InP, or the like, a shell (0.5 nm to 2 nm) such as ZnS, ZnSe, or the like, and a ligand for stabilizing the core and the shell, and may implement various colors according to sizes.

Table 1 below shows types of phosphors in applications fields of white light emitting devices using a blue LED (wavelength: 440 nm to 460 nm).

TABLE 1

| Purpose | Phosphors |
|---|---|
| LED TV BLU | β-SiAlON: Eu2+ |
| | (Ca,Sr)AlSiN3: Eu2+ |
| | L3Si6011: Ce3+ |
| | K2SiF6: Mn4+ |
| Lighting Devices | Lu3Al5012: Ce3+ |
| | Ca-α-SiAlON: Eu2+ |
| | L3Si6N11: Ce3+ |
| | (Ca,Sr)AlSiN3: Eu2+ |
| | Y3Al5012: Ce3+ |
| | K2SiF6: Mn4+ |
| Side Viewing | Lu3Al5012: Ce3+ |
| (Mobile, Notebook PC) | Ca-α-SiAlON: Eu2+ |
| | L3Si6N11: Ce3+ |
| | (Ca,Sr)AlSiN3: Eu2+ |
| | Y3Al5012: Ce3+ |
| | (Sr,Ba,Ca,Mg)2SiO4: Eu2+ |
| | K2SiF6: Mn4+ |
| Electrical Components | Lu3Al5012: Ce3+ |
| (Vehicle Head Lamp, etc.) | Ca-α-SiAlON: Eu2+ |
| | L3Si6N11: Ce3+ |
| | (Ca,Sr)AlSiN3: Eu2+ |
| | Y3Al5012: Ce3+ |
| | K2SiF6: Mn4+ |

Phosphors or quantum dots may be applied by using at least one of a method of spraying them on a light emitting device, a method of covering as a film, and a method of attaching as a sheet of ceramic phosphor, or the like.

As the spraying method, dispensing, spray coating, or the like, can be generally used, and dispensing may include a pneumatic method and a mechanical method such as a screw fastening scheme, a linear type fastening scheme, or the like. Through a jetting method, an amount of dotting may be controlled through a very small amount of discharging and color coordinates (or chromaticity) may be controlled therethrough. In the case of a method of collectively applying phosphors on a wafer level or on a mounting board on which an LED is mounted, productivity can be enhanced and a thickness can be easily controlled.

The method of directly covering a light emitting device with phosphors or quantum dots as a film may include electrophoresis, screen printing, or a phosphor molding method, and these methods may have a difference according to whether a lateral surface of a chip is required to be coated or not.

In order to control efficiency of a long wavelength light emitting phosphor re-absorbing light emitted in a short wavelength, among two types of phosphors having different light emitting wavelengths, two types of phosphor layer having different light emitting wavelengths may be provided, and in order to minimize re-absorption and interference of chips and two or more wavelengths, a DBR (ODR) layer may be included between respective layers. In order to form a uniformly coated film, after a phosphor is fabricated as a film or a ceramic form and attached to a chip or a light emitting device.

In order to differentiate light efficiency and light distribution characteristics, a light conversion material may be positioned in a remote form, and in this case, the light conversion material may be positioned together with a material such as a light-transmissive polymer, glass, or the like, according to durability and heat resistance.

A phosphor applying technique plays the most important role in determining light characteristics in an LED device, so techniques of controlling a thickness of a phosphor application layer, a uniform phosphor distribution, and the like, have been variously researched.

A quantum dot (QD) may also be positioned in a light emitting device in the same manner as that of a phosphor, and may be positioned in glass or a light-transmissive polymer material to perform optical conversion.

The lighting device using the LED as described above may be classified as an indoor lighting device or an outdoor lighting device according to the purpose thereof. The indoor LED lighting device may include a lamp, a fluorescent lamp (LED-tube), a flat panel type lighting device replacing an existing lighting fixture (retrofit), and the outdoor LED lighting device may include a streetlight, a security light, a flood light, a scene lamp, a traffic light, and the like.

Also, the lighting device using the LED may be utilized as an internal or external light source of a vehicle. As an internal light source, the lighting device using the LED may be used as an indoor light of a vehicle, a reading light, or as various dashboard light sources. As an external light source, the lighting device using the LED may be used as for a light source in vehicle lighting fixture such as a headlight, a brake light, a turn signal lamp, a fog light, a running light, and the like.

In addition, the LED lighting device may also be applicable as a light source used in robots or various mechanic facilities. In particular, LED lighting using light within a particular wavelength band may accelerate plant growth, and stabilize a user's mood or treat a disease using sensitivity (or emotional) illumination (or lighting).

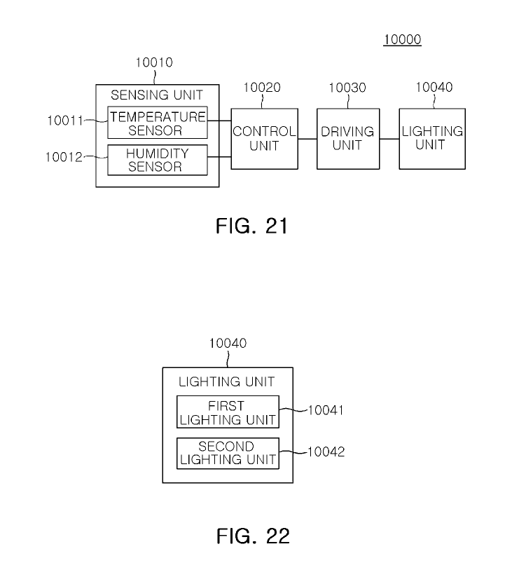

A lighting system employing the foregoing lighting device will be described with reference to FIGS. 21 through 24. The lighting system according to the present exemplary embodiment may automatically regulate a color temperature according to a surrounding environment (e.g., temperature and humidity) and provide a lighting device as sensitivity lighting meeting human sensitivity, rather than serving as simple lighting.

FIG. 21 is a block diagram schematically illustrating a lighting system according to an exemplary embodiment of the present disclosure.

Referring to FIG. 21, a lighting system 10000 according to an exemplary embodiment of the present disclosure may include a sensing unit 10010, a control unit 10020, a driving unit 10030, and a lighting unit 10040.

The sensing unit 10010 may be installed in an indoor or outdoor area, and may have a temperature sensor 10011 and a humidity sensor 10012 to measure at least one air condition among an ambient temperature and humidity. The sensing unit 10010 delivers the measured air condition, i.e., the measured temperature and humidity, to the control unit 10020 electrically connected thereto.

The control unit 10020 may compare the measured air temperature and humidity with air conditions (temperature and humidity ranges) previously set by a user, and determines a color temperature of the lighting unit 10040 corresponding to the air condition. To this end, the control unit 10020 may be electrically connected to the driving unit 10030, and control the lighting unit 10040 to be driven at the determined color temperature.

The lighting unit 10040 operates according to power supplied by the driving unit 10030. The lighting unit 10040 may include at least one lighting device illustrated in FIGS. 20 to 22. For example, as illustrated in FIG. 22, the lighting unit 10040 may include a first lighting device 10041 and a second lighting device 10042 having different color temperatures, and each of the lighting devices 10041 and 10042 may include a set of light emitting devices emitting the same white light.

The first lighting device 10041 may emit white light having a first color temperature, and the second lighting device 10042 may emit white light having a second color temperature, and here, the first color temperature may be lower than the second color temperature. Conversely, the first color temperature may be higher than the second color temperature. Here, white color having a relatively low color temperature corresponds to a warm white color, and white color having a relatively high color temperature corresponds to a cold white color. When power is supplied to the first and second lighting devices 10041 and 10042, the first and second lighting devices 10041 and 10042 emit white light having first and second color temperatures, respectively, and the respective white light may be mixed to implement white light having a color temperature determined by the control unit 10020.

In detail, in a case in which the first color temperature is lower than the second color temperature, if the color temperature determined by the control unit 10020 is relatively high, an amount of light from the first lighting device 10041 may be reduced and an amount of light from the second lighting device 10042 may be increased to implement mixed white light having the determined color temperature. Conversely, when the determined color temperature is relatively low, an amount of light from the first lighting device 10041 may be increased and an amount of light from the second lighting device 10042 may be reduced to implement white light having the determined color temperature. Here, the amount of light from each of the lighting devices 10041 and 10042 may be implemented by differently regulating an amount of power supplied from the driving unit 10030 or may be implemented by regulating the number of lighted light sources.

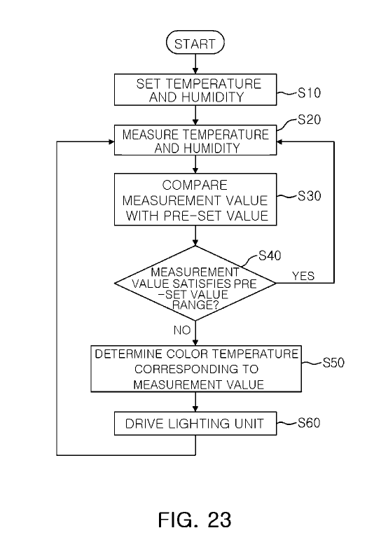

FIG. 23 is a flowchart illustrating a method for controlling the lighting system of FIG. 21. Referring to FIG. 23, first, the user sets a color temperature according to temperature and humidity ranges through the control unit 10020 of FIG. 21 (S10). The set temperature and humidity data are stored in the control unit 10020.

In general, when a color temperature is equal to or more than 6000K, a color providing a cool feeling, such as blue, may be produced, and when a color temperature is less than 4000K, a color providing a warm feeling, such as red, may be produced. Thus, in the present exemplary embodiment, when temperature and humidity exceed 20° C. and 60%, respectively, the user may set the lighting unit 10040 to be turned on to have a color temperature higher than 6000K through the control unit 10020, when temperature and humidity range from 10° C. to 20° C. and 40% to 60%, respectively, the user may set the lighting unit 10040 to be turned on to have a color temperature ranging from 4000K to 6000K through the control unit 10020, and when temperature and humidity are lower than 10° C. and 40%, respectively, the user may set the lighting unit 10040 to be turned on to have a color temperature lower than 4000K through the control unit 10020.

Next, the sensing unit 10010 measures at least one of conditions among ambient temperature and humidity (S20). The temperature and humidity measured by the sensing unit 10010 are delivered to the control unit 10020.

Subsequently, the control unit 10020 compares the measurement values delivered from the sensing unit 10010 with pre-set values, respectively (S30). Here, the measurement values are temperature and humidity data measured by the sensing unit 10010, and the set values are temperature and humidity data which have been set by the user and stored in the control unit 10020 in advance. Namely, the control unit 10020 compares the measured temperature and humidity with the pre-set temperature and humidity.

According to the comparison results, the control unit 10020 determines whether the measurement values satisfy the pre-set ranges (S40). When the measurement values satisfy the pre-set values, the control unit 10020 maintains a current color temperature, and measures again temperature and humidity (S20). Meanwhile, when the measurement values do not satisfy the pre-set values, the control unit 10020 detects pre-set values corresponding to the measurement values, and determines a corresponding color temperature (S50). The control unit 10020 controls the driving unit 10030 to cause the lighting unit 10040 to be driven at the determined color temperature.

Then, the driving unit 10030 drives the lighting unit 10040 to have the determined color temperature (S60). That is, the driving unit 10030 supplies required power to drive the lighting unit 10040 to implement the predetermined color temperature. Accordingly, the lighting unit 10040 may be adjusted to have a color temperature corresponding to the temperature and humidity previously set by the user according to ambient temperature and humidity.

In this manner, the lighting system 10000 is able to automatically regulate a color temperature of the indoor lighting according to changes in ambient temperature and humidity, thereby satisfying human moods varied according to changes in the surrounding natural environment and providing psychological stability.

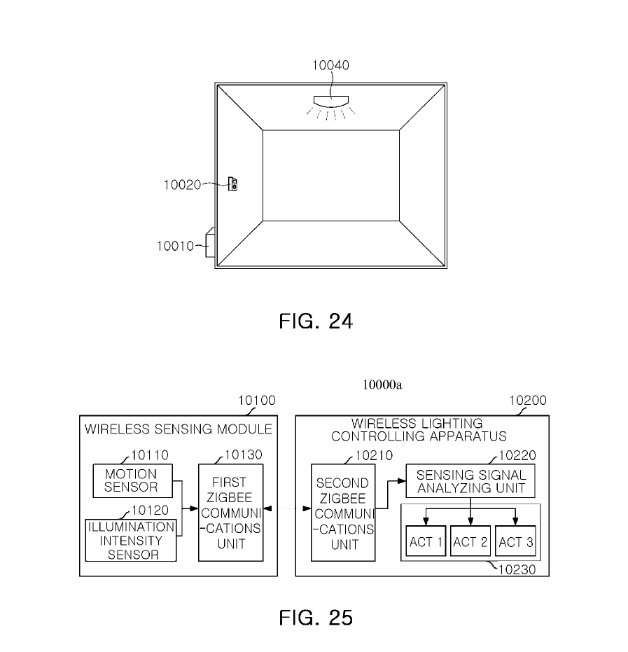

FIG. 24 is a view schematically illustrating the use of the lighting system of FIG. 21. As illustrated in FIG. 24, the lighting unit 10040 may be installed on the ceiling as an indoor lamp. Here, the sensing unit 10010 may be may be implemented as a separate device and installed on an external wall in order to measure outdoor temperature and humidity. The control unit 10020 may be installed in an indoor area to allow the user to easily perform setting and ascertainment operations. The lighting system is not limited thereto, but may be installed on the wall in the place of an interior illumination device or may be applicable to a lamp, such as a desk lamp, or the like, that can be used in indoor and outdoor areas.

Hereinafter, another example of a lighting system using the foregoing lighting device will be described with reference to FIGS. 25 through 28. The lighting system according to the present exemplary embodiment may automatically perform a predetermined control by detecting a motion of a monitored target and an intensity of illumination at a location of the monitored target.

FIG. 25 is a block diagram of a lighting system according to another exemplary embodiment of the present disclosure.

Referring to FIG. 25, a lighting system 10000a according to the present exemplary embodiment may include a wireless sensing module 10100 and a wireless lighting controlling device 10200.

The wireless sensing module 10100 may include a motion sensor 10110, an illumination intensity sensor 10120 sensing an intensity of illumination, and a first wireless communications unit generating a wireless signal that includes a motion sensing signal from the motion sensor 10110 and an illumination intensity sensing signal from the illumination intensity sensor 10120 and that complies with a predetermined communications protocol, and transmitting the same. The first wireless communications unit may be configured, for example, as a first ZigBee communications unit 10130 generating a ZigBee signal that complies with a pre-set communications protocol and transmitting the same.

The wireless lighting controlling device 10200 may include a second wireless communications unit receiving the wireless signal from the first wireless communications unit and restoring a sensing signal, a sensing signal analyzing unit 10220 analyzing the sensing signal from the second wireless communications unit, and an operation control unit 10230 performing a predetermined control based on analysis results from the sensing signal analyzing unit 10220. The second wireless communications unit may be configured as a second ZigBee communications unit 10210 receiving the ZigBee signal from the first ZigBee communications unit and restoring a sensing signal.

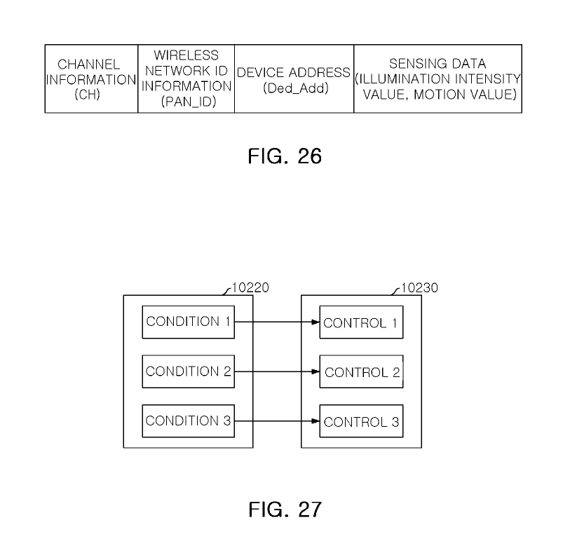

FIG. 26 is a view illustrating a format of a ZigBee signal according to an exemplary embodiment of the present disclosure.

Referring to FIG. 26, the ZigBee signal from the first ZigBee communications unit 10130 of FIG. 25 may include channel information (CH) defining a communications channel, wireless network identification (ID) information (PAN_ID) defining a wireless network, a device address (Ded_Add) designating a target device, and sensing data including the motion and illumination intensity sensing signal.

Also, the ZigBee signal from the second ZigBee communications unit 10210 of FIG. 25 may include channel information (CH) defining a communications channel, wireless network identification (ID) information (PAN_ID) defining a wireless network, a device address (Ded_Add) designating a target device, and sensing data including the motion and illumination intensity sensing signal.

The sensing signal analyzing unit 10220 of FIG. 25 may analyze the sensing signal from the second ZigBee communications unit 10210 of FIG. 25 to detect a satisfied condition, among a set of conditions, based on the sensed motion and the sensed intensity of illumination.

Here, the operation control unit 10230 of FIG. 25 may set a set of controls based on the set of conditions that are previously set by the sensing signal analyzing unit 10220 of FIG. 25, and perform a control corresponding to the condition detected by the sensing signal analyzing unit 10220.

FIG. 27 is a view illustrating the sensing signal analyzing unit and the operation control unit according to the exemplary embodiment of the present disclosure. Referring to FIG. 27, for example, the sensing signal analyzing unit 10220 of FIG. 25 may analyze the sensing signal from the second ZigBee communications unit 10210 of FIG. 25 and detect a satisfied condition among first, second, and third conditions (condition 1, condition 2, and condition 3), based on the sensed motion and sensed intensity of illumination.

In this case, the operation control unit 10230 may set first, second and third controls (control 1, control 2, and control 3) corresponding to the first, second, and third conditions (condition 1, condition 2, and condition 3) previously set by the sensing signal analyzing unit 10220 of FIG. 25, and perform a control corresponding to the condition detected by the sensing signal analyzing unit 10220.

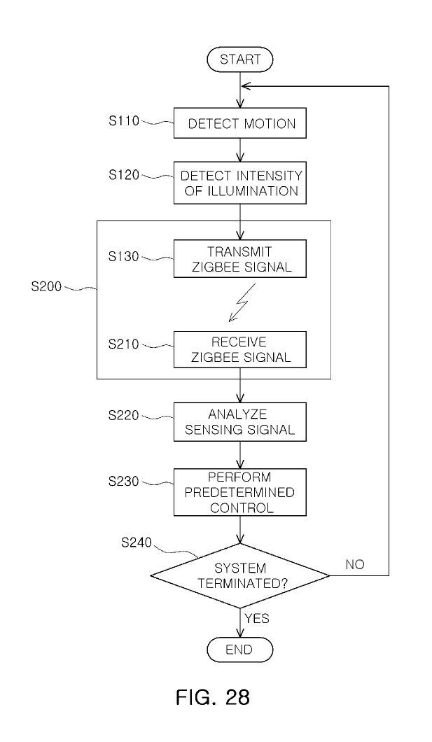

FIG. 28 is a flowchart illustrating an operation of a wireless lighting system according to an exemplary embodiment of the present disclosure.

In FIG. 28, in operation S110, the motion sensor 10110 of FIG. 25 detects a motion. In operation S120, the illumination intensity sensor 10120 detects an intensity of illumination. Operation 5200 is a process of transmitting and receiving a ZigBee signal. Operation 5200 may include operation S130 of transmitting a ZigBee signal by the first ZigBee communications unit 10130 and operation S210 of receiving the ZigBee signal by the second ZigBee communications unit 10210. In operation S220, the sensing signal analyzing unit 10220 analyzes a sensing signal. In operation S230, the operation control unit 10230 performs a predetermined control. In operation S240, it can be determined whether the lighting system is terminated.

Operations of the wireless sensing module and the wireless lighting controlling device according to an exemplary embodiment of the present disclosure will be described with reference to FIGS. 25 through 28.

First, with reference to FIGS. 25, 26, and 28, the wireless sensing module 10100 of FIG. 25 of the wireless lighting system according to an exemplary embodiment of the present disclosure will be described. The wireless lighting system 10100 according to the present exemplary embodiment can be installed in a location in which a lighting device is installed, to detect a current intensity of illumination of the lighting device and detect human motion near the lighting device.

Namely, the motion sensor 10110 of the wireless sensing module 10100 can be configured as an infrared sensor, or the like, capable of sensing a human. The motion sensor 10100 senses a motion and provides the same to the first ZigBee communications unit 10130 (S110 in FIG. 28). The illumination intensity sensor 10120 of the wireless sensing module 10100 senses an intensity of illumination and provides the same to the first ZigBee communications unit 10130 (S120).

Accordingly, the first ZigBee communications unit 10130 generates a ZigBee signal that includes the motion sensing signal from the motion sensor 10100 and the illumination intensity sensing signal from the illumination intensity sensor 10120 and that complies with a pre-set communications protocol, and transmits the generated ZigBee signal wirelessly (S130).

Referring to FIG. 26, the ZigBee signal from the first ZigBee communications unit 10130 may include channel information (CH) defining a communications channel, wireless network identification (ID) information (PAN_ID) defining a wireless network, a device address (Ded_Add) designating a target device, and sensing data, and here, the sensing data includes a motion value and an illumination intensity value.

Next, the wireless lighting controlling device 10200 of the wireless lighting system according to an exemplary embodiment of the present disclosure will be described with reference to FIGS. 25 through 28. The wireless lighting controlling device 10200 of the wireless lighting system according to the present exemplary embodiment may control a predetermined operation according to an illumination intensity value and a motion value included in a ZigBee signal from the wireless sensing module 10100.

Namely, the second ZigBee communications unit 10210 of the wireless lighting controlling device 10200 according to the present exemplary embodiment receives the ZigBee signal from the first ZigBee communications unit 10130, restores a sensing signal therefrom, and provides the restored sensing signal to the sensing signal analyzing unit 10200 (S210 in FIG. 28).

Referring to FIG. 25, the sensing signal analyzing unit 10220 analyzes the illumination intensity value and the motion value included in the sensing signal from the second ZigBee communications unit 10210 and provides the analysis results to the operation control unit 10230 (S220 in FIG. 28).

Accordingly, the operation control unit 10230 may perform a predetermined control according to the analysis results from the sensing signal analyzing unit 10220 (S230).

The sensing signal analyzing unit 10220 may analyze the sensing signal from the second ZigBee communications unit 10210 and detect a satisfied condition, among a set of conditions, based on the sensed motion and the sensed intensity of illumination. Here, the operation control unit 10230 may set a set of controls corresponding to the set of conditions set in advance by the sensing signal analyzing unit 10220, and perform a control corresponding to the condition detected by the sensing signal analyzing unit 10220.

For example, referring to FIG. 27, the sensing signal analyzing unit 10220 may detect a satisfied condition among the first, second, and third conditions (condition 1, condition 2, and condition 3) based on the sensed motion and the sensed intensity of illumination by analyzing the sensing signal from the second ZigBee communications unit 10210.

In this case, the operation control unit 10230 may set first, second, and third controls (control 1, control 2, and control 3) corresponding to the first, second, and third conditions (condition 1, condition 2, and condition 3) set in advance by the sensing signal analyzing unit 10220, and perform a control corresponding to the condition detected by the sensing signal analyzing unit 10220.

For example, when the first condition (condition 1) corresponds to a case in which human motion is sensed at a front door and an intensity of illumination at the front door is not low (not dark), the first control may turn off all predetermined lamps. When the second condition (condition 2) corresponds to a case in which human motion is sensed at the front door and an intensity of illumination at the front door is low (dim), the second control may turn on some pre-set lamps (i.e., some lamps at the front door and some lamps in a living room). When the third condition (condition 3) corresponds to a case in which human motion is sensed at the front door and an intensity of illumination at the front door is very low (a very dark environment), the third control may turn on all the pre-set lamps.

Unlike the foregoing cases, besides the operation of turning lamps on or off, the first, second, and third controls may be variously applied according to pre-set operations. For example, the first, second, and third controls may be associated with operations of a lamp and an air-conditioner in summer or may be associated with operations of a lamp and heating in winter.

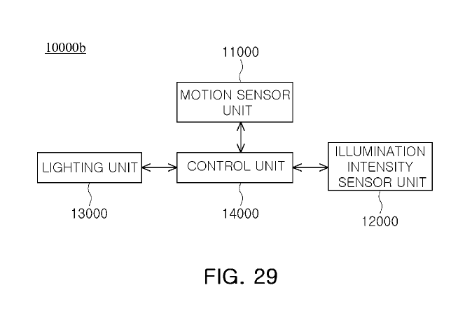

Other examples of a lighting system using the foregoing lighting device will be described with reference to FIGS. 29 through 32.

FIG. 29 is a block diagram schematically illustrating constituent elements of a lighting system according to another exemplary embodiment of the present disclosure. A lighting system 10000b according to the present exemplary embodiment may include a motion sensor unit 11000, an illumination intensity sensor unit 12000, a lighting unit 13000, and a control unit 14000.

The motion sensor unit 11000 senses a motion of an object. For example, the lighting system may be attached to a movable object, such as, for example, a container or a vehicle, and the motion sensor unit 11000 senses a motion of the moving object. When the motion of the object to which the lighting system is attached is sensed, the motion sensor unit 11000 outputs a signal to the control unit 14000 and the lighting system is activated. The motion sensor unit 11000 may include an accelerometer, a geomagnetic sensor, or the like.

The illumination intensity sensor unit 12000, a type of optical sensor, measures an intensity of illumination of a surrounding environment. When the motion sensor unit 11000 senses the motion of the object to which the lighting system is attached, the illumination intensity sensor unit 12000 can be activated according to a signal output by the control unit 14000. The lighting system illuminates during night work or in a dark environment to call a worker or an operator's attention to their surroundings, and allows a driver to secure visibility at night. Thus, even when the motion of the object to which the lighting system is attached is sensed, if an intensity of illumination higher than a predetermined level is secured (during the day), the lighting system may not be required to illuminate. Also, even in the daytime, if it rains, the intensity of illumination may be fairly low, so there may be a need to inform a worker or an operator about a movement of a container, and thus, the lighting unit may be required to emit light. Thus, whether to turn on the lighting unit 13000 can be determined according to an illumination intensity value measured by the illumination intensity sensor unit 12000.

The illumination intensity sensor unit 12000 can measure an intensity of illumination of a surrounding environment and outputs the measured value to the control unit 14000. Meanwhile, when the illumination intensity value is equal to or higher than a pre-set value, the lighting unit 13000 may not be required to emit light, so the overall system can be terminated.

When the illumination intensity value measured by the illumination intensity sensor unit 12000 is lower than the pre-set value, the lighting unit 13000 emits light. The worker or the operator may recognize the light emissions from the lighting unit 1300 to recognize the movement of the container, or the like. As the lighting unit 13000, the foregoing lighting device may be employed.

Also, the lighting unit 13000 may adjust intensity of light emissions thereof according to the illumination intensity value of the surrounding environment. When the illumination intensity value of the surrounding environment is low, the lighting unit 13000 may increase the intensity of light emissions thereof, and when the illumination intensity value of the surrounding environment is relatively high, the lighting unit 13000 may decrease the intensity of light emissions thereof, thus preventing power wastage.

The control unit 14000 controls the motion sensor unit 1100, the illumination intensity sensor unit 12000, and the lighting unit 13000 overall. When the motion sensor unit 11000 senses the motion of the object to which the lighting system is attached, and outputs a signal to the control unit 14000, the control unit 14000 outputs an operation signal to the illumination intensity sensor unit 12000. The control unit 14000 receives an illumination intensity value measured by the illumination intensity sensor unit 12000 and determines whether to turn on (operate) the lighting unit 13000.

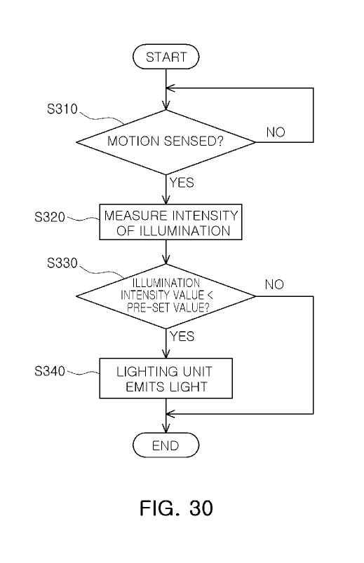

FIG. 30 is a flowchart illustrating a method for controlling a lighting system. Hereinafter, a method for controlling a lighting system will be described with reference to FIG. 30.

First, a motion of an object to which the lighting system is attached can be sensed and an operation signal can be output (S310). For example, the motion sensor unit 11000 may sense a motion of a container or a vehicle in which the lighting system is installed, and when the motion of the container or the vehicle is sensed, the motion sensor unit 11000 outputs an operation signal. The operation signal may be a signal for activating overall power. Namely, when the motion of the container or the vehicle is sensed, the motion sensor unit 11000 outputs the operation signal to the control unit 14000.

Next, based on the operation signal, an intensity of illumination of a surrounding environment can be measured and an illumination intensity value can be output (S320). When the operation signal is applied to the control unit 14000, the control unit 14000 outputs a signal to the illumination intensity sensor unit 12000, and then the illumination intensity sensor unit 12000 measures the intensity of illumination of the surrounding environment. The illumination intensity sensor unit 12000 outputs the measured illumination intensity value of the surrounding environment to the control unit 14000. Thereafter, whether to turn on the lighting unit can be determined according to the illumination intensity value, and the lighting unit can emit light according to the determination.

First, the illumination intensity value can be compared with a pre-set value for a determination (S330). When the illumination intensity value is input to the control unit 14000, the control unit 14000 compares the received illumination intensity value with a stored pre-set value and determines whether the former is lower than the latter. Here, the pre-set value can be a value for determining whether to turn on the lighting device. For example, the pre-set value may be an illumination intensity value at which a worker or a driver may have difficulty in recognizing an object with the naked eye or may make a mistake in a situation, for example, a situation in which the sun starts to set.

When the illumination intensity value measured by the illumination intensity sensor unit 12000 is higher than the pre-set value, lighting of the lighting unit may not be required, so the control unit 14000 may shut down the overall system.

Meanwhile, when the illumination intensity value measured by the illumination intensity sensor unit 12000 is lower than the pre-set value, lighting of the lighting unit may be required, so the control unit 14000 can output a signal to the lighting unit 13000 and the lighting unit 13000 emits light (S340).

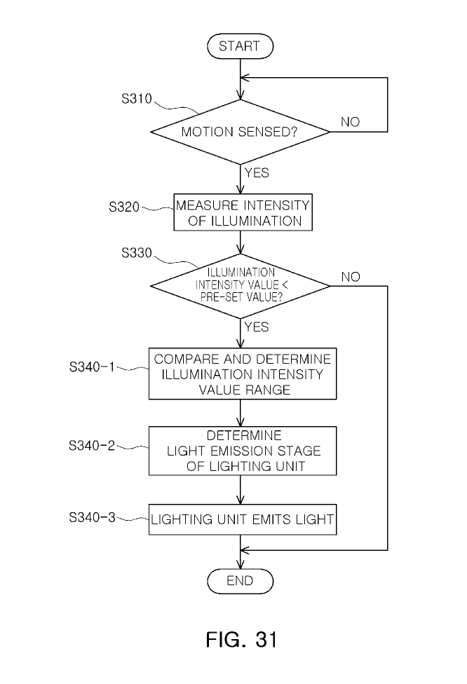

FIG. 31 is a flowchart illustrating a method for controlling a lighting system according to another exemplary embodiment of the present disclosure. Hereinafter, a method for controlling a lighting system according to another exemplary embodiment of the present disclosure will be described. However, the same procedure as that of the method for controlling a lighting system as described above with reference to FIG. 30 will be omitted.

As illustrated in FIG. 31, in the case of the method for controlling a lighting system according to the present exemplary embodiment, an intensity of light emissions of the lighting unit may be regulated according to an illumination intensity value of a surrounding environment.

As described above, the illumination intensity sensor unit 12000 outputs an illumination intensity value to the control unit 14000 (S320). When the illumination intensity value is lower than a pre-set value (S330), the control unit 14000 determines a range of the illumination intensity value (S340-1). The control unit 14000 has a range of subdivided illumination intensity value, based on which the control unit 14000 can determine the range of the measured illumination intensity value.

Next, when the range of the illumination intensity value is determined, the control unit 14000 can determine an intensity of light emissions of the lighting unit (S340-2), and accordingly, the lighting unit 13000 emits light (S340-3). The intensity of light emissions of the lighting unit may be divided according to the illumination intensity value, and here, the illumination intensity value varies according to weather, time, and surrounding environment, so the intensity of light emissions of the lighting unit may also be regulated. By regulating the intensity of light emissions according to the range of the illumination intensity value, power wastage may be prevented and a worker or an operator's attention may be drawn to their surroundings.

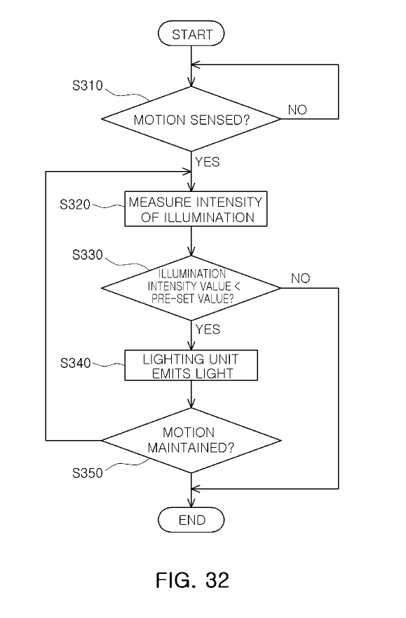

FIG. 32 is a flowchart illustrating a method for controlling a lighting system according to another exemplary embodiment of the present disclosure. Hereinafter, a method for controlling a lighting system according to another exemplary embodiment of the present disclosure will be described. However, the same procedure as that of the method for controlling a lighting system as described above with reference to FIGS. 30 and 31 will be omitted.

The method for controlling a lighting system according to the present exemplary embodiment may further include operation S350 of determining whether a motion of an object to which the lighting system is attached is maintained in a state in which the lighting unit 13000 emits light, and determining whether to maintain light emissions.

First, when the lighting unit 13000 of FIG. 29 starts to emit light, termination of the light emissions may be determined based on whether a container or a vehicle to which the lighting system is installed moves. Here, when the motion of the container is stopped, it may be determined that an operation thereof has terminated. In addition, when a vehicle temporarily stops at a crosswalk, light emissions of the lighting unit may be stopped to prevent interference with the vision of oncoming drivers.

When the container or the vehicle moves again, the motion sensor unit 11000 operates and the lighting unit 13000 may start to emit light.

Whether to maintain light emissions may be determined based on whether a motion of an object to which the lighting system is attached can be sensed by the motion sensor unit 11000. When the motion of the object is continuously sensed by the motion sensor unit 11000, an intensity of illumination can be measured again and whether to maintain light emissions can be determined. Meanwhile, when the motion of the object is not sensed, the system may be terminated.

The lighting device using an LED as described above may be altered in terms of an optical design thereof according to a product type, a location, and a purpose. For example, in relation to the foregoing sensitivity illumination, a technique for controlling lighting by using a wireless (remote) control technique utilizing a portable device such as a smartphone, in addition to a technique of controlling a color, temperature, brightness, and a hue of illumination (or lighting) may be provided.

Also, in addition, a visible wireless communications technology aimed at achieving a unique purpose of an LED light source and a purpose as a communications unit by adding a communications function to LED lighting devices and display devices may be available. This can be because, an LED light source advantageously has a longer lifespan and excellent power efficiency, implements various colors, supports a high switching rate for digital communications, and can be available for digital control, in comparison to existing light sources.

The visible light wireless communications technology is a wireless communications technology transferring information wirelessly by using light having a visible light wavelength band recognizable by humans' eyes. The visible light wireless communications technology can be distinguished from a wired optical communications technology in the aspect that it uses light having a visible light wavelength band, and distinguished from a wired optical communications technology in the aspect that a communications environment is based on a wireless scheme.

Also, unlike RF wireless communications, the visible light wireless communications technology has excellent convenience and physical security properties in that it can be freely used without being regulated or permitted in the aspect of frequency usage, is differentiated in that a user can check a communications link with his/her eyes, and above all, the visible light wireless communications technology has features as a fusion technique (or converging technology) obtaining a unique purpose as a light source and a communications function.

As set forth above, according to exemplary embodiments of the present disclosure, the lighting device capable of implementing a light distribution at a luminous viewing angle substantially the same as that of the conventional light bulbs can be provided.

In addition, the lighting device capable of securing sufficient cooling performance by having a cooling structure with a size within an ANSI standard range to overcome limited heat dissipation efficiency of natural cooling can be provided.

Advantages and effects of the present disclosure are not limited to the foregoing content and any other technical effects not mentioned herein may be easily understood from the descriptions of the specific exemplary embodiments of the present disclosure.

While exemplary embodiments have been shown and described above, it will be apparent to those skilled in the art that modifications and variations could be made without departing from the spirit and scope of the present disclosure as defined by the appended claims.

What is claimed is:

1. A lighting device comprising:
a housing; and
a plurality of light source modules detachably fixed to one surface of the housing,
wherein the plurality of light source modules are divided radially on the basis of a central axis penetrating through a center of the housing and partial surfaces of the respective adjacent light source modules are combined to define an external shape of the lighting device.

2. The lighting device of claim 1, wherein the plurality of light source modules have flow paths allowing air to flow therethrough between the plurality of light source modules and the housing.

3. The lighting device of claim 2, wherein the plurality of light source modules each have a slider formed in a surface thereof facing the housing and fastened to the housing.

4. The lighting device of claim 3, wherein the plurality of light source modules are in line-contact with the housing through one protruded surface of each of the sliders, and are spaced apart from the housing by the sliders interposed between the plurality of light source modules and the housing to form the flow paths.

5. The lighting device of claim 1, wherein each of the light source modules comprises:
a frame having a first surface and a second surface facing one another, the second surface having a recess depressed toward the first surface and defined as a space formed by a sloped surface sloped from the second surface toward a bottom surface and a pair of side walls extending from both edges of the bottom surface and connected to both edges of the sloped surface;
a light source placed on the bottom surface of the frame; and
a cover covering the light source.

6. The lighting device of claim 5, wherein the pair of side walls satisfies the following conditional expression:
θ=360°/n,
wherein when an intersection point of the central axis and virtual extending lines of the pair of side walls is used as a vertex, “θ” is an angle between the pair of side walls on the basis of the vertex and “n” is a number of the light source modules.

7. The lighting device of claim 3, wherein the housing further comprises a fixing unit protruded from the one surface thereof along the central axis, and a plurality of slots are provided on a circumference of a side of the fixing unit to allow the sliders to be fastened thereto.

8. The lighting device of claim 7, wherein the plurality of slots each extend from an open end of the fixing unit to the one surface, formed to be spaced apart on the circumference of the side of the fixing unit and arranged to be parallel to the central axis.

9. The lighting device of claim 7, wherein a plurality of grooves are each formed on the one surface of the housing and connected to the plurality of slots, and the plurality of grooves each extend radially from the fixing unit positioned in the center to an outer surface of the housing.

10. The lighting device of claim 5, wherein the light source comprises a board and a plurality of light emitting devices placed on the board.

11. The lighting device of claim 10, wherein each of the light emitting devices comprises a plurality of nano-light emitting structures and a filler material filling spaces between the plurality of nano-light emitting structures,
wherein each of the nano-light emitting structures comprises a nano-core as a first conductivity-type semiconductor layer and an active layer and a second conductivity-type semiconductor layer covering the nano-core as shell layers.

12. A lighting device comprising:
a housing having a fixing unit; and
a plurality of light source modules divided radially on a basis of a central axis passing through a center of the fixing unit and detachably fastened to the fixing unit in a length direction to surround the fixing unit,
wherein partial surfaces of the respective adjacent light source modules are combined to define an external shape of the lighting device.

13. The lighting device of claim 12, wherein the plurality of light source modules each have a slider protruded from a center of a lower surface facing the housing toward the housing and extending in the length direction of the fixing unit,
wherein protruded ends of the sliders are partially fastened to a plurality of slots formed on a circumference of a side of the fixing unit.

14. The lighting device of claim 13, wherein lower surfaces of the plurality of light source modules are spaced apart from a surface of the housing, and flow paths allowing air to flow therethrough are formed between the lower surfaces of the plurality of light source modules and the surface of the housing.

15. The lighting device of claim 12, wherein gaps allowing air to be released therethrough exist between the plurality of divided light source modules.

16. A lighting system comprising:
a sensing unit measuring at least one air condition;
a control unit analyzing the at least one air condition measured by the sensing unit;
a driving unit supplying power; and
a lighting unit operating according to the power supplied by the driving unit, the lighting unit comprising at least one lighting device,
wherein the control unit determines a color temperature of the lighting unit based on the analyzing.

17. The lighting system of claim 16, wherein each lighting device of the lighting unit comprises:
a housing; and
a plurality of light source modules detachably fixed to one surface of the housing,
wherein the plurality of light source modules are divided radially on the basis of a central axis penetrating through a center of the housing and partial surfaces of the respective adjacent light source modules are combined to define an external shape of the lighting device.

18. The lighting system of claim 17, wherein the at least one air condition measured by the sensing unit includes temperature and humidity.

19. The lighting system of claim 17, wherein the lighting unit comprises a first lighting device emitting a first light having a first color temperature and a second lighting device emitting a second light having a second color temperature, and wherein
the control unit mixes the first light and the second light to implement the color temperature determined for the lighting unit based on the first color temperature and the second color temperature.

20. The lighting system of claim 17, wherein the control unit receives a pre-set color temperature from a user, and
Wherein the control unit analyzes the at least one measured air condition by comparing the at least one measured air condition with the pre-set color temperature.
